(19) United States
(12) Patent Application Publication
(10) Pub. No.: US 2026/0238935 A1
(43) Pub. Date: Aug. 13, 2026

(54) DISPLAY DEVICE AND DEVICE CONTROL METHOD

(71) Applicant: HISENSE VISUAL TECHNOLOGY CO., LTD., Qingdao (CN)

(72) Inventors: Jianzhu XIU, Qingdao (CN); Na DONG, Qingdao (CN)

(21) Appl. No.: 19/633,508

(22) Filed: Mar. 30, 2026

Related U.S. Application Data
(63) Continuation of application No. PCT/CN2024/084230, filed on Mar. 27, 2024.

(30) Foreign Application Priority Data
Dec. 12, 2023 (CN) 202311706430.0
Feb. 26, 2024 (CN) 202410210570.7

(51) Int. Cl. H04R 25/00

(52) U.S. Cl. CPC H04R 25/554; H04R 2225/55

(57) ABSTRACT

The present disclosure relates to the technical field of Bluetooth, and relates to a display device and a device control method. The device control method comprises: obtaining a list of paired Bluetooth devices; adding, into a same device group of a target display list, target Bluetooth devices in the list of paired Bluetooth devices having a same connection state and a same HiSyncID, wherein the target Bluetooth devices support an ASHA protocol; and controlling a display to display, on the basis of the target display list, a first group identifier and a connection state identifier corresponding to the first group identifier, wherein the first group identifier is used for identifying a first device group in the target display list, and the connection state identifier is used for representing the connection state of the target Bluetooth devices in the first device group.

### CROSS-REFERENCE TO RELATED APPLICATIONS

The present disclosure is a continuation application of PCT/CN2024/084230, filed on March 27, 2024, which claims priority to Chinese patent applications No. 202410210570.7, filed on February 26, 2024, and No. 202311706430.0, filed on December 12, 2023, the entire contents of all of which are incorporated herein by reference.

### TECHNICAL FIELD

The present disclosure relates to the field of Bluetooth technology, and in particular to a display device and a device control method.

### BACKGROUND

With the continuous development of Bluetooth technology, Bluetooth devices supporting the ASHA (Audio Streaming for Hearing Aid) protocol have emerged, such as Bluetooth headsets supporting the ASHA protocol. For Bluetooth devices supporting the ASHA protocol, a device control method is urgently needed.

### SUMMARY

In a first aspect, the present disclosure provides a display device, including: a display, configured to present an image and/or a user input interface; the user input interface, configured to receive a command from a user; a Bluetooth module, configured to perform an operation related to a Bluetooth protocol; a communicator, configured to communicate with an external device based on a predetermined protocol; a memory, configured to store data associated with the display device and computer instructions; and at least one processor, connected to the display, the user input interface, the Bluetooth module, the communicator, and the memory, and configured to execute the computer instructions to cause the display device to: obtain a list of paired Bluetooth devices; where the list of paired Bluetooth devices includes at least one Bluetooth device; add target Bluetooth devices with the same connection state and Hearing Instrument Synchronization (HiSyncID) in the list of paired Bluetooth devices to one device group in a target display list; where the target Bluetooth devices support an Audio Streaming for Hearing Aid (ASHA) protocol, the connection state includes a connected state and an unconnected state, the target display list includes at least a first device group, and the first device group includes at least two target Bluetooth devices; and control the display to present a first group identifier and a connection state identifier corresponding to the first group identifier based on the target display list; where the first group identifier is used to identify the first device group in the target display list, and the connection state identifier is used to indicate the connection state of the target Bluetooth devices in the first device group.

In a second aspect, the present disclosure provides a device control method, including: obtaining a list of paired Bluetooth devices; where the list of paired Bluetooth devices includes at least one Bluetooth device; adding target Bluetooth devices with the same connection state and Hearing Instrument Synchronization identifier (HiSyncID) in the list of paired Bluetooth devices to one device group in a target display list; where the target Bluetooth devices support an Audio Streaming for Hearing Aid (ASHA) protocol, the connection state includes a connected state and an unconnected state, and the target display list includes at least a first device group, and the first device group includes at least two target Bluetooth devices; and control the display to present a first group identifier and a connection state identifier corresponding to the first group identifier based on the target display list; where the first group identifier is used to identify the first device group in the target display list, and the connection state identifier is used to indicate the connection state of the target Bluetooth devices in the first device group.

### BRIEF DESCRIPTION OF FIGURES

FIG. 1 is a schematic diagram of a scenario architecture of a device control method according to some embodiments.

FIG. 2 is a configuration block diagram of a control apparatus 100 according to some embodiments.

FIG. 3 is a configuration block diagram of a display device 200 according to some embodiments.

FIG. 4 is a hardware configuration block diagram of a terminal device 300 according to some embodiments.

FIG. 5 is a configuration block diagram of a Bluetooth device 400 according to some embodiments.

FIG. 6 is a schematic diagram of an operating system of a display device 200 according to some embodiments.

FIG. 7 is a schematic diagram of a software system architecture of a display device 200 according to some embodiments.

FIG. 8 is a schematic flow chart of a method for controlling a Bluetooth device according to some embodiments.

FIG. 9 is a schematic diagram showing a display effect of a target Bluetooth device when connection states and HiSyncIDs of target Bluetooth devices are the same according to some embodiments.

FIG. 10 is a schematic diagram of a device management page according to some embodiments.

FIG. 11 is a schematic diagram of another device management page according to some embodiments.

FIG. 12 is a schematic flow chart of another method for controlling a Bluetooth device according to some embodiments.

FIG. 13 is a schematic flow chart of another method for controlling a Bluetooth device according to some embodiments.

FIG. 14 is a schematic processing diagram when updating connection states of target Bluetooth devices according to some embodiments.

FIG. 15 is a schematic diagram of updating a device management page according to some embodiments.

FIG. 16 is a schematic diagram of updating another device management page according to some embodiments.

FIG. 17 is a schematic display processing flow chart for Bluetooth devices according to some embodiments.

FIG. 18 is a schematic flow chart of another device control method according to some embodiments.

FIG. 19 is a schematic flow chart of another device control method according to some embodiments.

FIG. 20 is a schematic flow chart of another device control method according to some embodiments.

FIG. 21 is a schematic flow chart of another device control method according to some embodiments.

FIG. 22 is a schematic diagram of a volume adjustment page according to some embodiments.

FIG. 23 is a schematic diagram of a scenario in which audio data is synchronized after a display device is restarted according to some embodiments.

FIG. 24 is a schematic structural diagram of an electronic device according to some embodiments.

### DETAILED DESCRIPTION

ASHA (Audio Streaming for Hearing Aid) protocol is a hearing aid audio transmission protocol based on Bluetooth Low Energy (BLE). ASHA is a technical specification designed specifically for connecting hearing aids to Android devices. This Android direct connection technical specification will allow people to use their hearing devices to enjoy music, answer calls, etc., just like using headphones. At the same time, this technical specification aims to further extend battery life. Using Bluetooth Low Energy (BLE), users can use audio direct connection technology around the clock while still ensuring the battery life of Bluetooth devices.

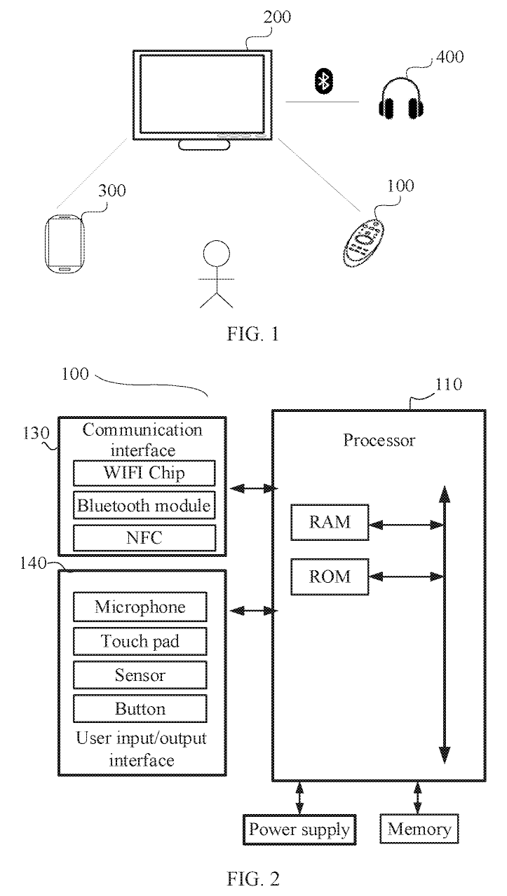

FIG. 1 is a schematic diagram of a scenario architecture of a device control method according to some embodiments. As shown in FIG. 1, the scenario architecture according to some embodiments may include: a control apparatus 100, a display device 200, a terminal device 300, and a Bluetooth device 400.

The user can operate the display device 200 through the terminal device 300 or the control apparatus 100. A Bluetooth connection is established between the display device 200 and the Bluetooth device 400, and the display device 200 can perform data exchange with the Bluetooth device 400 through the Bluetooth connection.

According to some embodiments, the display device 200 may have various implementation forms. For example, the display device 200 may be a television, a smart speaker refrigerator with a display function, a curtain with a display function, a personal computer (PC), a laser projection device, a monitor, an electronic bulletin board, a wearable device, a vehicle-mounted device, an electronic table, etc. The present disclosure does not limit this.

In some embodiments, the control apparatus 100 may be a remote controller, and the communication between the remote controller and the display device 200 may be infrared protocol communication, Bluetooth protocol communication, or other short-range communication manners, and the display device 200 may be controlled wirelessly or wired. The user may input user commands through keys on the remote controller, voice input, control panel input, etc., to control the display device 200. In some embodiments, the control apparatus 100 may also be a terminal device (such as a mobile phone, a tablet computer, a computer, a laptop computer, etc.). For example, the display device 200 is controlled using an application running on the terminal device.

In some embodiments, the display device 200 may also be controlled by a terminal device 300 (such as a mobile phone, a tablet computer, a computer, a laptop computer, etc.). For example, the display device 200 may be controlled by an application program running on a smart device.

In some embodiments, the display device 200 can also be controlled in a manner other than the control apparatus 100. For example, the display device 200 can directly receive the user’s voice command control through a module for obtaining voice commands configured inside the display device 200, or receive the user’s key operation through physical keys on the display device 200, or receive the user’s touch operation through a touch control panel of the display device 200.

In some embodiments, the display device 200 can also communicate data with the server to obtain relevant media resources from the server. The display device 200 can be allowed to communicate with the server through a local area network (LAN) or a wireless local area network (WLAN). The server can provide media resource services and various content and interactions to the display device 200. The server can be a cluster or multiple clusters, and can include one or more types of servers.

FIG. 2 exemplarily shows a configuration block diagram of the control apparatus 100 in the embodiment shown in FIG. 1. As shown in FIG. 2, the control apparatus 100 may include: at least one of a processor 110, a communication interface 130, a user input/output interface 140, a memory, or a power supply. The control apparatus 100 may receive an operation command input by a user, and convert the operation command into a command that can be recognized and responded to by the display device 200, and send the operation command or a command obtained by converting the voice command to the display device 200, thereby playing the role of an interactive intermediary between the user and the display device 200.

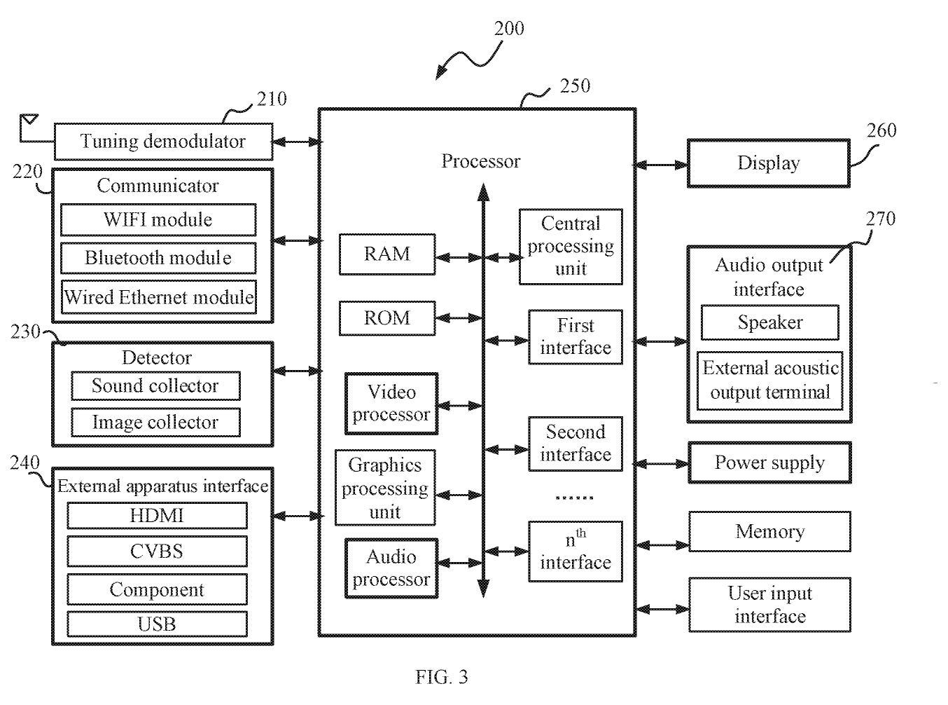

FIG. 3 exemplarily shows a configuration block diagram of the display device 200 in the embodiment shown in FIG. 1. As shown in FIG. 3, the display device 200 may include: at least one of a tuning demodulator 210, a communicator 220, a detector 230, an external device interface 240, a processor 250, a display 260, an audio output interface 270, a memory, a power supply, or a user input interface.

In some embodiments, the tuning demodulator 210 receives broadcast television signals by wired or wireless reception, and demodulates multiple wireless or wired broadcast television signals to obtain audio and video signals, such as Electronic Program Guide (EPG) data signals. In some embodiments, the tuning demodulator 210 can be located in different split devices, that is, the tuning demodulator 210 can also be in an external device, such as an external set-top box, of the physical device where the processor 250 is located.

The communicator 220 is a component that can be used to communicate with external devices (such as the processor 100, the server 400, etc.) according to various communication protocol types. For example, the communicator 220 may include at least one of a WiFi module, a Bluetooth module, a wired Ethernet module, other network communication protocol chips, a near field communication protocol chip, or an infrared receiver. The display device 200 can send and receive control signals and data signals with external devices through the communicator 220.

The detector 230 can be used to collect signals of the external environment or interaction with the outside. For example, the detector 230 may include a light receiver, which can be used as a sensor for collecting the intensity of ambient light; or, the detector 230 may include an image collector, such as a camera, which can be used to collect external environment scenarios, user attributes or user interaction gestures; or, the detector 230 may include a sound collector, such as a microphone, which can be used to receive external sounds.

The external device interface 240 may include, but is not limited to, any one or more of the following: a high-definition multimedia interface (HDMI), an analog or digital high-definition component input interface (component), a composite video input interface (CVBS), a Universal Serial Bus (USB), an RGB port, etc. It may also be a composite input/output interface formed by the above multiple interfaces.

The processor 250 controls the operation of the display device and responds to user operations through various software control programs stored in the memory. The processor 250 controls the overall operation of the display device 200. For example, in response to receiving a user command for selecting a user interface (UI) object to be presented on the display 260, the processor 250 can perform operations related to the object selected by the user command.

In some embodiments, the processor may include at least one of a central processing unit (CPU), a video processor, an audio processor, a graphics processing unit (GPU), Random Access Memory (RAM), Read-Only Memory (ROM), a first interface to an n^{th} interface that can be used for input/output, or a communication bus (Bus), etc.

The display 260 may include a display screen component that can be used to present images and a driving component that drives the image display, and can be used to receive image signals output from the processor, and display video content, image content, menu control interface components, and user control interface.

The display 260 may be a liquid crystal display, an Organic Light-Emitting Diode (OLED) display, or a projection display, and may also be a projection apparatus and a projection screen.

The user may input a user command through a graphical user interface (GUI) presented on the display 260, and the user input interface receives the user input command through the graphical user interface (GUI). Alternatively, the user may input a user command through a specific sound or gesture, and the user input interface recognizes the sound or gesture through a sensor to receive the user input command.

Among them, the user interface is the medium interface for interaction and information exchange between the application or operating system and the user, which realizes the conversion between the internal form of information and the form acceptable to the user. The commonly used form of user interface is the Graphical User Interface (GUI), which refers to the user interface related to computer operation displayed in a graphical way. It can be an interface element such as an icon, window, control, etc., displayed on the display screen of an electronic device, where the control can include visual interface elements, such as icons, buttons, menus, tabs, text boxes, dialog boxes, status bars, navigation bars, or widgets, etc.

The audio output interface 270 is an audio output component that can be used to output audio signals, and may include a speaker, an external audio output terminal, and the like.

The user input interface may be used to receive control signals input by the user through the control apparatus 100 (e.g., an infrared remote controller, etc.) or through touch or gesture.

For the scenario shown in FIG. 1, when implementing the device control method according to some embodiments, the components in the display device 200 may implement the following functions.

In some embodiments, at least one processor is connected to a display, a user input interface, a Bluetooth module, a communicator, and a memory, and is configured to execute computer instructions to cause the display device to: obtain a list of paired Bluetooth devices; where the list of paired Bluetooth devices may include at least one Bluetooth device; add target Bluetooth devices with the same connection state and Hearing Instrument Synchronization identifier (HiSyncID) in the list of paired Bluetooth devices to one device group in a target display list; where the target Bluetooth devices support the ASHA protocol, the connection state may include a connected state and an unconnected state, the target display list may include at least a first device group, and the first device group may include at least two target Bluetooth devices; and control the display to present a first group identifier and a connection state identifier corresponding to the first group identifier based on the target display list; where the first group identifier can be used to identify the first device group in the target display list, and the connection state identifier can be used to indicate the connection state of the target Bluetooth devices in the first device group.

In some embodiments, the at least one processor is further configured to execute the computer instructions to cause the display device to: before adding the target Bluetooth devices with the same connection state and HiSyncID in the list of paired Bluetooth devices to one device group in the target display list, obtain the connection state of the target Bluetooth devices in the list of paired Bluetooth devices; and obtain the HiSyncID of the target Bluetooth devices based on Universally Unique Identifiers (UUIDs) reported by the target Bluetooth device.

In some embodiments, for the adding the target Bluetooth devices with the same connection state and HiSyncID in the list of paired Bluetooth devices to one device group in the target display list, it is further configured to execute the computer instructions to cause the display device to: traverse the list of paired Bluetooth devices, and match a HiSyncID of a first target Bluetooth device in the list of paired Bluetooth devices against the HiSyncID of the target Bluetooth devices in each device group in the target display list; and in response to that the HiSyncID of the first target Bluetooth device successfully matches a HiSyncID of a second target Bluetooth device in a second device group, add the first target Bluetooth device to the second device group.

In some embodiments, the at least one processor is further configured to execute the computer instructions to cause the display device to: if the HiSyncID of the first target Bluetooth device fails to match the HiSyncID of the target Bluetooth devices in each device group in the target display list, create a third device group for the first target Bluetooth device in the target display list, and add the first target Bluetooth device to the third device group.

In some embodiments, the at least one processor is further configured to execute the computer instructions to cause the display device to: in response to a connection state switching message for a third target Bluetooth device, determine a quantity of target Bluetooth devices in a fourth device group where the third target Bluetooth device is located; if it is determined that the quantity of target Bluetooth devices in the fourth device group is greater than 1, remove the third target Bluetooth device from the fourth device group, create a fifth device group for the third target Bluetooth device in the target display list, and add the third target Bluetooth device to the fifth device group; where a device identifier of the third target Bluetooth device is presented in the fifth device group.

In some embodiments, the at least one processor is further configured to execute the computer instructions to cause the display device to: if it is determined that the quantity of target Bluetooth devices in the fourth device group is not greater than 1, update a connection state of the third target Bluetooth device in the fourth device group.

In some embodiments, the target display list may further include a sixth device group, and the sixth device group may include a fourth target Bluetooth device; and the at least one processor is further configured to execute the computer instructions to cause the display device to: control the display to present a device identifier, a left or right ear identifier, and a connection state identifier of the fourth target Bluetooth device based on the target display list; where the left or right ear identifier can be used to identify that the fourth target Bluetooth device belongs to the left ear or the right ear.

In some embodiments, the at least one processor is further configured to execute the computer instructions to cause the display device to: in response to a target interaction operation for any target Bluetooth device in the first device group, perform interaction processing corresponding to the target interaction operation on each target Bluetooth device in the first device group; where the target interaction operation may include at least one of an unpairing operation, a disconnection operation, or a reconnection operation.

In some embodiments, the first group identifier is a device identifier of a target Bluetooth device that is preferentially added to the first device group.

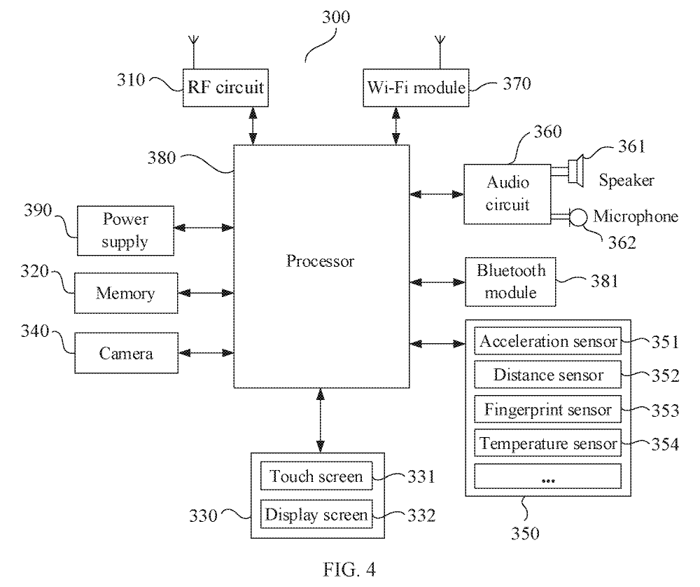

FIG. 4 exemplarily shows a hardware configuration block diagram of a terminal device 300 in the embodiment shown in FIG. 1. It should be understood that the terminal device 300 shown in FIG. 4 is only an example, and the terminal device 300 may have more or fewer components than those shown in FIG. 4, may combine two or more components, or may have different component configurations. The various components shown in FIG. 4 may be implemented in hardware, software, or a combination of hardware and software that may include one or more signal processing and/or application specific integrated circuits.

As shown in FIG. 4, the terminal device 300 may include: a radio frequency (RF) circuit 310, a memory 320, a display unit 330, a camera 340, a sensor 350, an audio circuit 360, a wireless fidelity (Wi-Fi) module 370, a processor 380, a Bluetooth module 381, a power supply 390, and other components.

The RF circuit 310 can be used to receive and send signals during the process of sending and receiving information or making calls, can receive downlink data from the base station and hand it over to the processor 380 for processing, and can send uplink data to the base station. The memory 320 can be used to store software programs and data. The memory 320 stores an operating system that enables the terminal device 300 to run. The memory 320 in the present disclosure can store an operating system and various application programs, and can further store program codes for executing the device control method implemented based on the terminal device in some embodiments of the present disclosure.

The display unit 330 may be used to receive input numeric or character information and generate signal input related to user settings and function control of the terminal device 300. The display unit 330 may include a touch screen 331, which can collect user touch operations on or near it (e.g., clicking a button), disposed on the front of the terminal device 300.

The display unit 330 may further be used to display information input by the user or information provided to the user, and a graphical user interface (GUI) of various menus of the terminal device 300. The display unit 330 may include a display screen 332 disposed on the front of the terminal device 300. The touch screen 331 may be covered on the display screen 332, or the touch screen 331 and the display screen 332 may be integrated to realize the input and output functions of the terminal device 300, and the integrated touch screen and display screen may be referred to as a touch display screen. The terminal device 300 may further include at least one type of sensors 350, such as an acceleration sensor 351, a distance sensor 352, a fingerprint sensor 353, and a temperature sensor 354.

The audio circuit 360, the speaker 361, and the microphone 362 can provide an audio interface between the user and the terminal device 300. Wi-Fi is a short-range wireless transmission technology. The terminal device 300 can help the user to send and receive emails, browse web pages, and access streaming media through the Wi-Fi module 370, which provides the user with wireless broadband Internet access.

The processor 380 is the control center of the terminal device 300, uses various interfaces and lines to connect various parts of the entire terminal device, and executes various functions of the terminal device 300 and processes data by running or executing software programs stored in the memory 320 and calling data stored in the memory 320. In some embodiments, the processor 380 may include one or more processing units; or the processor 380 may also integrate an application processor and a baseband processor, where the application processor mainly processes the operating system, user interface, and application programs, etc., and the baseband processor mainly processes wireless communications. It should be understood that the above-mentioned baseband processor may not be integrated into the processor 380. In the present disclosure, the processor 380 can run an operating system, application programs, user interface display, and touch response.

The Bluetooth module 381 can be used to exchange information with other Bluetooth devices having Bluetooth modules through the Bluetooth protocol. For example, the terminal device 300 can establish a Bluetooth connection with a display device that also has a Bluetooth module through the Bluetooth module 381 to exchange data. The terminal device 300 may further include a power supply 390 (such as a battery) for supplying power to each component.

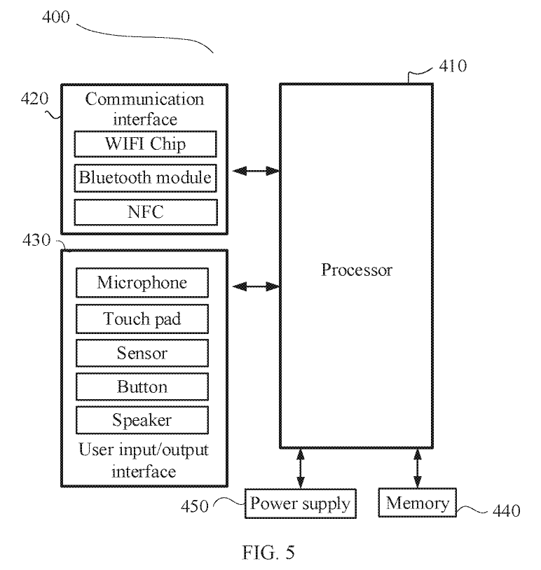

FIG. 5 exemplarily shows a configuration block diagram of the Bluetooth device 400 in the embodiment shown in FIG. 1. As shown in FIG. 5, the Bluetooth device 400 may include: a processor 410, a communicator 420, a user input/output interface 430, a memory 440, and a power supply 450. The communicator 420 can be used to communicate with the outside, and includes at least one of a WIFI chip, a Bluetooth module, NFC, or an alternative module. The user input/output interface 430 includes at least one of a speaker, a microphone, a touchpad, a sensor, a button, or an alternative module.

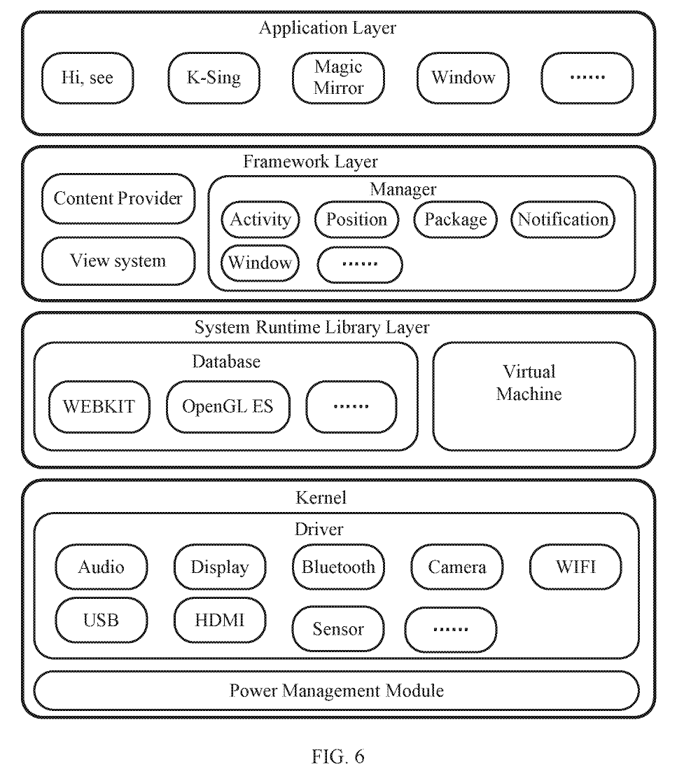

As shown in FIG. 6, in some embodiments, the operating system of the display device 200 is divided into four layers, from top to bottom, namely, the application (Applications) layer, the application framework layer (referred to as “framework layer”), the Android runtime, the system library layer (referred to as “system runtime library layer”), and the kernel layer.

In some embodiments, at least one application is running in the application layer, and these applications can be window programs, system settings programs, clock programs, etc., provided by the operating system, or applications developed by third-party developers. In specific implementations, the application packages in the application layer are not limited to the above examples.

The framework layer provides application programming interfaces (APIs) and programming frameworks for applications. The application framework layer may include some predefined functions. The application framework layer is equivalent to a processing center that determines the actions that applications in the application layer take. Through the API interface, applications can access system resources and obtain system services during execution.

As shown in FIG. 6, the application framework layer in the embodiment of the present disclosure may include managers, and content providers, etc., where the manager may include at least one of the following modules: an activity manager configured for interacting with all activities running in the system; a location manager configured for providing system services or applications with access to system location services; a package manager configured for retrieving various information related to applications currently installed on the device; a notification manager configured for controlling the displaying and clearing of notification messages; or a window manager configured for managing icons, windows, toolbars, wallpapers, and desktop widgets on the user interface.

In some embodiments, the activity manager can be used to manage the life cycle of each application and the common navigation back function, such as controlling the exit, opening, and back of the application. The window manager can be used to manage all window programs, such as obtaining the display screen size, determining whether there is a status bar, locking the screen, capturing the screen, and controlling the display window changes (for example, reducing the display window, shaking the display, distorting the display, etc.).

In some embodiments, the system runtime library layer provides support for the upper layer, namely the framework layer. When the framework layer is used, the Android operating system will run the C/C++ library contained in the system runtime library layer to implement the functions to be implemented by the framework layer.

In some embodiments, the kernel layer is a layer between hardware and software. As shown in FIG. 6, the kernel layer includes at least one of the following drivers: audio driver, display driver, Bluetooth driver, camera driver, WIFI driver, USB driver, HDMI driver, sensor driver (such as fingerprint sensor, temperature sensor, pressure sensor, etc.), or power driver, etc.

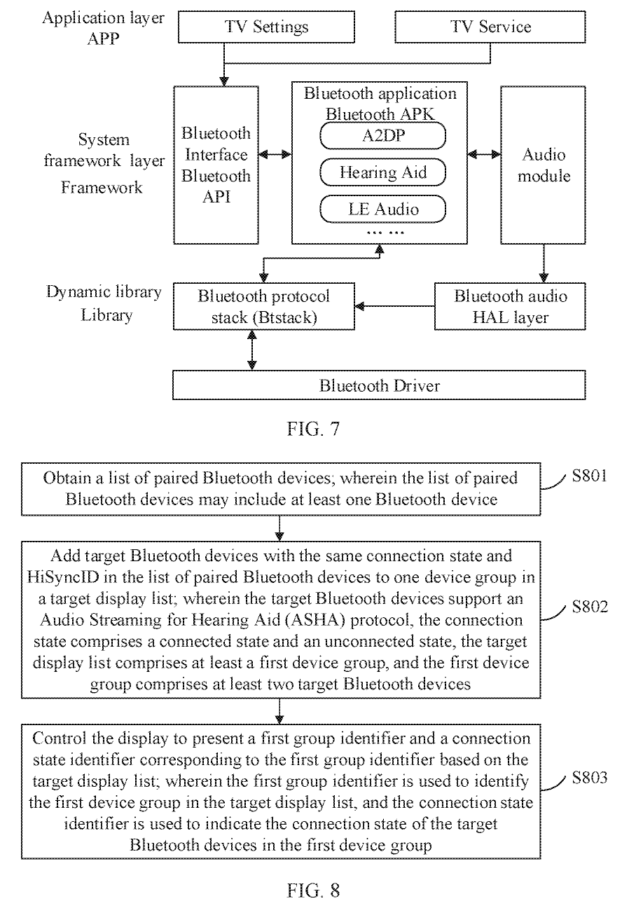

FIG. 7 is a schematic diagram of a software system architecture of the display device 200 according to some embodiments. As shown in FIG. 7, the software system may include: an application (App) layer, a system framework layer (referred to as “framework layer”), a dynamic library and a Bluetooth driver.

The application layer may include: TV settings or TV services.

The system framework layer may include: Bluetooth interface (e.g., Bluetooth Application Programming Interface (API)), Bluetooth application (e.g., Bluetooth Android Application Package (APK)), and audio module.

Bluetooth applications may include: Advanced Audio Distribution Profile (A2DP) application specification, Low Energy (LE) Audio application specification, and ASHA application specification. Among them, A2DP application specification is the media audio application specification in classic Bluetooth, LE Audio application specification is the low-power audio application specification based on Bluetooth, and ASHA application specification is the hearing aid audio transmission protocol of Bluetooth Low Energy (BLE). In the embodiment of the present disclosure, the technology of ASHA protocol is mainly used to realize the display of Bluetooth device.

The dynamic library may include: Bluetooth protocol stack and Bluetooth audio Hardware Abstraction Layer (HAL) layer, where the Bluetooth protocol stack is mainly responsible for scanning, connecting and configuring Bluetooth devices, etc. During the display device establishes a Bluetooth connection with the Bluetooth device, the Bluetooth application in the display device can send relevant data to the Bluetooth protocol stack.

The audio module may include an audio manager, an audio service, etc. The audio module is mainly responsible for sending audio-related data from the Bluetooth application to the Bluetooth protocol stack.

The Bluetooth driver is mainly responsible for the Bluetooth connection between the display device and surrounding Bluetooth devices.

The foregoing has described in detail the communication architecture of Bluetooth devices supporting the ASHA protocol, the hardware configuration of the display device and related Bluetooth devices, and the software system architecture of the display device. The Bluetooth application of the display device has integrated the ASHA application specification, enabling Bluetooth communication with Bluetooth devices supporting the ASHA protocol. In the ASHA protocol, HiSyncID (Hearing Instrument Synchronization identifier) is a key characteristic in the ASHA GATT service, which is fully used to uniquely identify a pair of hearing aids (left ear and right ear), and can be referred to as SyncID for short; and these expressions are synonymous and both refer to the hearing instrument synchronization identifier. In a binaural hearing aid system, it is determined whether the left and right hearing aids belong to the same pair of devices by reading their SyncIDs. If the SyncIDs of the two hearing aids are the same, the mobile phone will identify them as a “pair” and establish a stereo connection; if they are different, they are regarded as two independent mono devices.

The traditional Bluetooth device management logic uses the MAC address of the Bluetooth device as the sole identification basis, treats each physical device as an independent entry, and directly displays the Bluetooth device corresponding to each MAC address as an independent item on the display interface based on the device name, connection state, and protocol type identified by UUID. This logic is applicable to single-ended traditional Bluetooth audio devices. For example, for an ordinary Bluetooth headset under the A2DP protocol, due to the adoption of a “single-device relay” logic (the display device only connects to the primary device, and the secondary device communicates via a private protocol), only one MAC address exists from the perspective of the display device, so it is displayed as a single entry.

This, however, does not match the design characteristics of the ASHA protocol. For Bluetooth devices supporting the ASHA protocol, the left and right ear Bluetooth devices respectively have different MAC addresses. The ASHA protocol, as a low-power audio transmission protocol specifically designed for hearing aid-type Bluetooth devices, has one of its core design features being the configuration of the HiSyncID identifier. This identifier is written and firmly set by the device manufacturer. The left and right ear devices of the same set of binaural hearing aid Bluetooth devices have exactly the same HiSyncID, which is used to clarify the pairing binding relationship of the binaural devices and is the core basis for identifying a binaural device group under the ASHA protocol.

However, display devices that have not been adapted, because they do not recognize and utilize the above-mentioned role of HiSyncID, only independently identify and display binaural Bluetooth devices supporting the ASHA protocol based on their MAC addresses. This causes the same set of binaural devices to be split into two unrelated independent devices displayed on the management interface. This not only prevents users from intuitively identifying the pairing relationship of the binaural devices, leading to confusion in perceiving the device connection states, but also requires users to perform operations such as connecting, disconnecting, and unpairing the binaural devices separately, resulting in cumbersome operations and low efficiency, while also failing to achieve refined control over the binaural devices.

To solve the above technical problems, the present disclosure, aiming at the design features of the ASHA protocol, proposes a display device and a device control method adapted for Bluetooth devices supporting the ASHA protocol. The core idea is to use HiSyncID as the core basis for grouping Bluetooth devices supporting the ASHA protocol, perform group management on target Bluetooth devices in combination with the device connection states, and perform unified display and control based on the grouping results, effectively solving the adaptation defects between the traditional management logic and Bluetooth devices supporting the ASHA protocol. The device control method provided by the embodiments of the present disclosure will be described in detail below with reference to FIG. 8.

FIG. 8 exemplarily shows a schematic flow chart of a device control method according to some embodiments. The execution subject of the method may be the display device 200 in the embodiment shown in FIG. 1. FIG. 8 is a schematic flow chart of a device control method according to some embodiments. The method may include the following steps.

S801: a list of paired Bluetooth devices is obtained; where the list of paired Bluetooth devices may include at least one Bluetooth device.

In an embodiment of the present disclosure, the list of paired Bluetooth devices may include at least one Bluetooth device, where the at least one Bluetooth device may include Bluetooth devices that have been paired with the display device, such as a Bluetooth device supporting the ASHA protocol, a Bluetooth device supporting the A2DP protocol, a Bluetooth device supporting the LE Audio protocol, etc.

In practice, the Bluetooth device may include information such as connection state and device type; where the connection state may include a connected state and an unconnected state, etc. The connected state may be used to indicate that a Bluetooth connection has been established between the Bluetooth device and the display device, and the unconnected state may be used to indicate that a Bluetooth connection has not been established between the Bluetooth device and the display device; the device type of the Bluetooth device may be used to indicate the Bluetooth protocols supported by the Bluetooth device, such as support for ASHA protocol type, support for A2DP protocol type, or support LE Audio protocol type, etc.

S802: target Bluetooth devices with the same connection state and HiSyncID in the list of paired Bluetooth devices are added to one device group in a target display list.

In the embodiment of the present disclosure, after obtaining the list of paired Bluetooth devices including at least one Bluetooth device, based on the device type and connection state saved in the list of paired Bluetooth devices, Bluetooth devices with the same connection state and HiSyncID in the list of paired Bluetooth devices are determined as target Bluetooth devices; where the target Bluetooth devices may be Bluetooth devices that supports the ASHA protocol.

In the embodiment of the present disclosure, HiSyncID is a set of fixed values written by the Bluetooth device manufacturer for the Bluetooth device. The display device can determine whether the Bluetooth device is in the same group of devices with other Bluetooth devices based on the HiSyncID of the Bluetooth device. In practice, for each dual-audio-channel device, its HiSyncID is unique. For left audio channel setting and right audio channel setting, their HiSyncIDs must be the same. Bytes 0-1 of HiSyncID are the manufacturer’s identifier, and bytes 2-7 are unique identifiers that can be used to identify the Bluetooth device group.

In the embodiment of the present disclosure, after determining the target Bluetooth devices with the same connection state and HiSyncID from the list of paired Bluetooth devices, the target Bluetooth devices are added to one device group in the target display list.

In the embodiment of the present disclosure, the target display list may include one or more device groups. In practice, Bluetooth devices with the same connection state and HiSyncID may be determined as one device group, that is, the Bluetooth devices in the one device group have the same connection state and HiSyncID. Among them, the first device group may be any device group, and the first device group may include at least two target Bluetooth devices, the connection states of the two target Bluetooth devices are the same, and the HiSyncIDs of the two target Bluetooth devices are the same.

In some embodiments, before adding the target Bluetooth devices with the same connection state and HiSyncID in the list of paired Bluetooth devices to one device group in the target display list, the method may further include: obtaining the connection state of the target Bluetooth devices in the list of paired Bluetooth devices; and obtaining the HiSyncID of the target Bluetooth devices based on UUIDs reported by the target Bluetooth devices.

In practice, UUID can be used to identify the services provided by a Bluetooth device. By scanning the list of UUIDs broadcast by a Bluetooth device, it can be determined whether the device supports the A2DP, LE Audio (Low Energy Audio) or ASHA (Audio Streaming for Hearing Aid) protocol. Since the UUID of the Bluetooth device supporting the ASHA protocol is different from the UUID of the Bluetooth device supporting the LE Audio protocol, the UUID can be used to identify whether the Bluetooth device supports the ASHA protocol. When a Bluetooth device is determined to be a device that supports the ASHA protocol type through the UUID (that is, when the Bluetooth device is a target Bluetooth device that supports the ASHA protocol), the HiSyncID of the target Bluetooth device can be obtained based on the UUID of the target Bluetooth device.

In some embodiments, since the target Bluetooth device provides Audio Streaming for Hearing Aid (ASHA) Generic Attribute Profile (GATT) service to the outside, the display device can send a GATT query request to the target Bluetooth device. The target Bluetooth device, in response to the query request, reports the UUID of the target Bluetooth device to the display device. Furthermore, the display device can obtain the HiSyncID of the target Bluetooth device based on the UUID of the target Bluetooth device.

In the embodiment of the present disclosure, after obtaining the list of paired Bluetooth devices and the connection state of the target Bluetooth device in the list of paired Bluetooth devices, and obtaining the HiSyncID of the target Bluetooth device based on the UUID reported by the target Bluetooth device, the target Bluetooth devices with the same connection state and HiSyncID can also be added to the same one device group in the target display list.

Exemplarily, assume that the list of paired Bluetooth devices may include Bluetooth device A, Bluetooth device B, Bluetooth device C and Bluetooth device D; where the obtained HiSyncID corresponding to the Bluetooth device A is 11, and the obtained connection state thereof is unconnected; the HiSyncID corresponding to the Bluetooth device B is 22, and the connection state thereof is connected; the HiSyncID corresponding to the Bluetooth device C is 11, and the connection state thereof is unconnected; and the HiSyncID corresponding to the Bluetooth device D is 22, and the connection state thereof is connected.

Among the above Bluetooth devices, the connection states and HiSyncIDs of the Bluetooth device B and the Bluetooth device D are the same, the Bluetooth device B and the Bluetooth device D are added to the same one device group, e.g., a device group 1, in the target display list. In addition, the target display list may further include a device group 2, where the device group 2 may include a Bluetooth device E (HiSyncID is 33, connection state is not connected) and a Bluetooth device F (HiSyncID is 33, connection state is not connected).

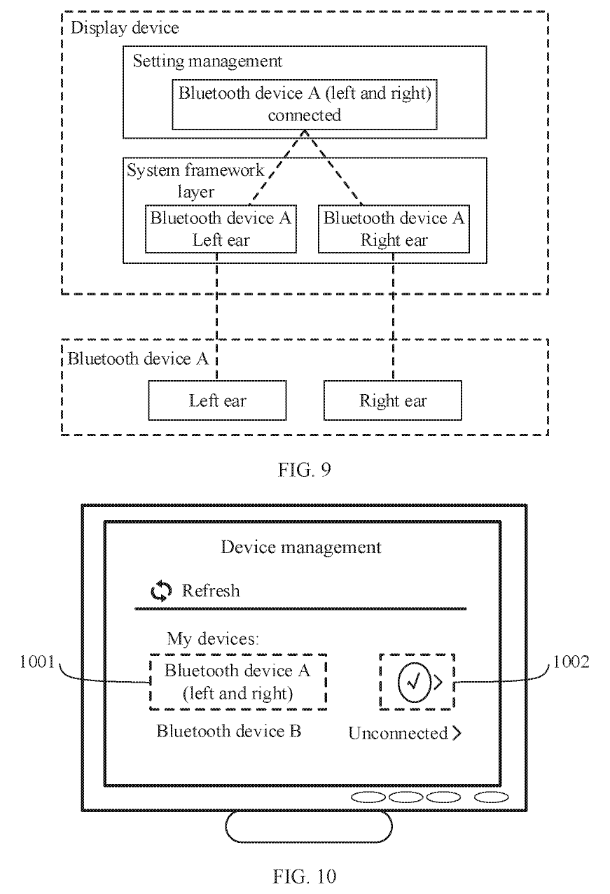

FIG. 9 is a schematic diagram of a display effect of a target Bluetooth device when the connection state and HiSyncID each is the same according to some embodiments. Among them, in the system framework layer, multiple target Bluetooth devices in the same one device group are identified by left ear devices and right ear devices respectively. Setting management can be used to present the display effect of the target Bluetooth device on the display. For target Bluetooth devices with the same connection state and HiSyncID, only one device group is displayed on the device management page, such as “Bluetooth device A (left and right), connected”.

S803: the display is controlled to present a first group identifier and a connection state identifier corresponding to the first group identifier based on the target display list.

The first group identifier may be used to identify the first device group in the target display list, and the connection state identifier may be used to indicate the connection state of the target Bluetooth devices in the first device group.

In the embodiment of the present disclosure, the target display list may include at least the first device group, and the first device group may include at least two target Bluetooth devices with the same connection state and HiSyncID.

In the embodiment of the present disclosure, after the target Bluetooth devices with the same connection state and HiSyncID in the list of paired Bluetooth devices are added to the same one device group in the target display list, the display is controlled to present the first group identifier and the connection state identifier corresponding to the first group identifier based on the target display list.

In the embodiment of the present disclosure, the first group identifier may be used to identify the first device group in the target display list, and the connection state identifier may be used to indicate the connection state of the target Bluetooth devices in the first device group.

In some embodiments, the first group identifier may be a device identifier of a target Bluetooth device that is preferentially added to the first device group. Exemplarily, the device identifier, e.g., a device name, of the target Bluetooth device firstly added to the first device group may be determined as the first group identifier corresponding to the first device group.

FIG. 10 is a schematic diagram of a device management page according to some embodiments, where a first group identifier 1001 corresponding to a first device group may be presented on the device management page, and a connection state 1002 of a target Bluetooth device in the first device group may be further presented thereon. The first group identifier may include a device name of the target Bluetooth device, such as “Bluetooth device A (left and right)”, and the connection state may include a display word of “connected” or “unconnected”, a connected icon or an unconnected icon, etc.

In an optional implementation, the target display list may further include a sixth device group, and the sixth device group may only include the fourth target Bluetooth device. Therefore, when controlling the display to present the first group identifier and the connection state identifier corresponding to the first group identifier based on the target display list, the display may also be controlled to present the device identifier, the left or right ear identifier, and the connection state identifier of the fourth target Bluetooth device based on the target display list.

In the embodiment of the present disclosure, the left or right ear identifier may be used to identify that the fourth target Bluetooth device belongs to the left ear or the right ear.

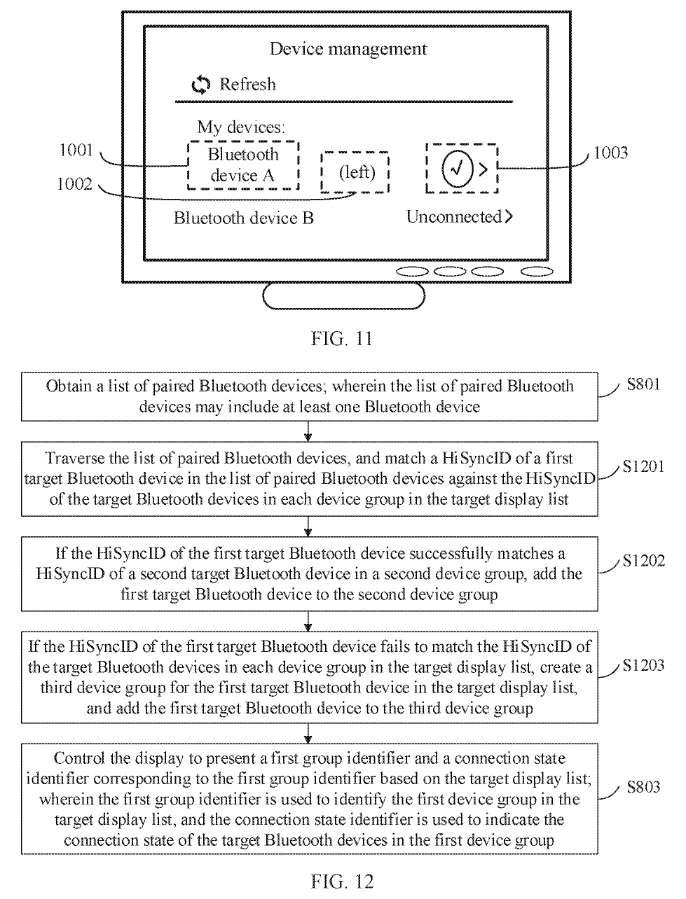

FIG. 11 is a schematic diagram of another device management page according to some embodiments, where the sixth device group where the fourth target Bluetooth device is located can only include the fourth target Bluetooth device, and the device identifier 1101, the left or right ear identifier 1102, and the connection state identifier 1103 of the fourth target Bluetooth device are presented on this page.

In the device control method according to some embodiments, first, the list of paired Bluetooth devices is obtained, where the list of paired Bluetooth devices may include at least one Bluetooth device; then, the target Bluetooth devices with the same connection state and HiSyncID in the list of paired Bluetooth devices are added to the same one device group in the target display list, where the target Bluetooth device supports the ASHA protocol, the connection state may include a connected state and an unconnected state, the target display list may include at least a first device group, and the first device group may include at least two target Bluetooth devices; further, the display is controlled to present a first group identifier and a connection state identifier corresponding to the first group identifier based on the target display list; where the first group identifier can be used to identify the first device group in the target display list, and the connection state identifier can be used to indicate the connection state of the target Bluetooth devices in the first device group. It can be seen that, in the embodiment of the present disclosure, the target Bluetooth devices with the same connection state and HiSyncID can be added to the same one device group, and be presented as the same device group on the display, thereby realizing the display function for Bluetooth devices supporting the ASHA protocol.

FIG. 12 is an extension and refinement of the embodiment shown in FIG. 8, on the basis of steps S801 to S803 shown in FIG. 8, the above step S802 (adding the target Bluetooth devices with the same connection state and HiSyncID in the list of paired Bluetooth devices to the same one device group in the target display list) is replaced with steps S1201 to S1203. The device control method according to some embodiments may further include the following steps.

S801: a list of paired Bluetooth devices is obtained; where the list of paired Bluetooth devices may include at least one Bluetooth device.

S1201: the list of paired Bluetooth devices is traversed, and a HiSyncID of a first target Bluetooth device in the list of paired Bluetooth devices is matched against the HiSyncID of the target Bluetooth devices in each device group in the target display list.

In the embodiment of the present disclosure, the target Bluetooth device is a Bluetooth device that supports the ASHA protocol. The list of paired Bluetooth devices may include one or more target Bluetooth devices. The first target Bluetooth device may be any target Bluetooth device. The target display list may include at least one device group, and each device group corresponds to one or more target Bluetooth devices.

In the embodiment of the present disclosure, after the list of paired Bluetooth devices is obtained, the list of paired Bluetooth devices is traversed, and the HiSyncID of the first target Bluetooth device in the list of paired Bluetooth devices is matched with the HiSyncID of the target Bluetooth device in each device group in the target display list.

S1202: if the HiSyncID of the first target Bluetooth device successfully matches a HiSyncID of a second target Bluetooth device in a second device group, the first target Bluetooth device is added to the second device group.

In the embodiment of the present disclosure, the second device group belongs to a device group in the target display list, and the second device group may include at least a second target Bluetooth device. The HiSyncID of the second target Bluetooth device is the same as the HiSyncID of the first target Bluetooth device. After the first target Bluetooth device is added to the second device group, the second target Bluetooth device and the first target Bluetooth device are devices in the same one device group (i.e., the second device group).

In some embodiments, the list of paired Bluetooth devices can also be traversed to match the HiSyncID and connection state of the first target Bluetooth device in the list of paired Bluetooth devices with the HiSyncID and connection state of the target Bluetooth devices in each device group in the target display list, so that when it is determined that the HiSyncID and connection state of the first target Bluetooth device successfully match the HiSyncID and connection state of the second target Bluetooth device in the second device group, the first target Bluetooth device can be added to the second device group.

S1203: if the HiSyncID of the first target Bluetooth device fails to match the HiSyncID of the target Bluetooth devices in each device group in the target display list, a third device group is created for the first target Bluetooth device in the target display list, and the first target Bluetooth device is added to the third device group.

In the embodiment of the present disclosure, if it is determined that the HiSyncID of the first target Bluetooth device fails to match the HiSyncID of the target Bluetooth device in any device group in the target display list, it means that the first target Bluetooth device and any target Bluetooth device in the target display list are not devices in the same one group. At this time, a new device group, i.e., the third device group, is created for the first target Bluetooth device in the target display list, and the first target Bluetooth device is added to the newly created third device group.

S803: the display is controlled to present a first group identifier and a connection state identifier corresponding to the first group identifier based on the target display list.

The first group identifier may be used to identify the first device group in the target display list, and the connection state identifier may be used to indicate the connection state of the target Bluetooth devices in the first device group.

In the device control method according to some embodiments, first, a list of paired Bluetooth devices is obtained, where the list of paired Bluetooth devices may include at least one Bluetooth device; then, the list of paired Bluetooth devices is traversed, and the HiSyncID of the first target Bluetooth device in the list of paired Bluetooth devices is matched with the HiSyncID of the target Bluetooth devices in each device group in the target display list, and when it is determined that the HiSyncID of the first target Bluetooth device successfully matches the HiSyncID of the second target Bluetooth device in the second device group, the first target Bluetooth device is added to the second device group; further, the display is controlled to present the first group identifier and the connection state identifier corresponding to the first group identifier based on the target display list; where the first group identifier can be used to identify the first device group in the target display list, and the connection state identifier can be used to indicate the connection state of the target Bluetooth devices in the first device group. It can be seen that, in the embodiment of the present disclosure, the target Bluetooth devices with the same connection state and HiSyncID can be added to the same device group, and be presented as the same one device group on the display, thereby realizing the display function of Bluetooth devices supporting the ASHA protocol.

In addition, when it is determined that the HiSyncID of the first target Bluetooth device has not been successfully matched with any target Bluetooth device in the second device group, in the embodiment of the present disclosure, the third device group is created for the first target Bluetooth device in the target display list and the first target Bluetooth device group is added to the third device group, thereby realizing the display function of Bluetooth devices that support the ASHA protocol.

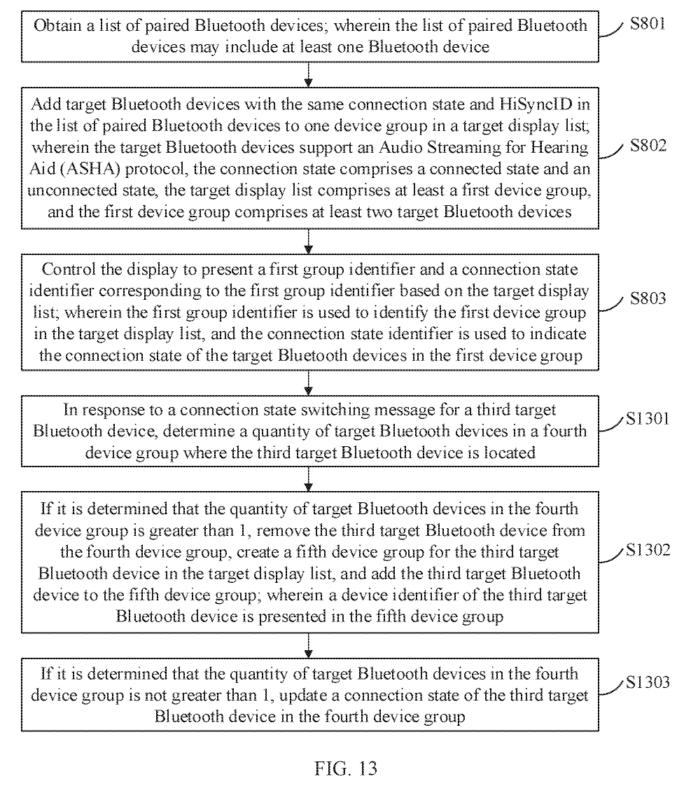

FIG. 13 is an extension and refinement of the embodiment shown in FIG. 8, on the basis of steps S801 to S803 shown in FIG. 8, steps S1301 to S1303 may also be included. According to some embodiments, the device control method may further include the following steps.

S801: a list of paired Bluetooth devices is obtained; where the list of paired Bluetooth devices may include at least one Bluetooth device.

S802: target Bluetooth devices with the same connection state and HiSyncID in the list of paired Bluetooth devices are added to one device group in a target display list.

The target Bluetooth device supports the ASHA protocol, the connection state may include a connected state and an unconnected state, the target display list may include at least a first device group, and the first device group may include at least two target Bluetooth devices.

S803: the display is controlled to present a first group identifier and a connection state identifier corresponding to the first group identifier based on the target display list, where the first group identifier may be used to identify the first device group in the target display list, and the connection state identifier may be used to indicate the connection state of the target Bluetooth devices in the first device group.

S1301: in response to a connection state switching message for a third target Bluetooth device, a quantity of target Bluetooth devices in a fourth device group where the third target Bluetooth device is located is determined.

In the embodiment of the present disclosure, the third target Bluetooth device can be any target Bluetooth device in the target display list, and the connection state switching message for the third target Bluetooth device may include a message that the third target Bluetooth device switches from a connected state to an unconnected state, or a message that the third target Bluetooth device switches from an unconnected state to a connected state, etc.

In the embodiment of the present disclosure, when the display device receives a connection state switching message for the third target Bluetooth device, it first determines the quantity of target Bluetooth devices in the fourth device group where the third target Bluetooth device is located. Exemplarily, the target display list may include a device group 1 (a target Bluetooth device A and a target Bluetooth device B), a device group 2 (a target Bluetooth device C and a target Bluetooth device D), and a device group 2 (a target Bluetooth device E). When the connection state switching message for the target Bluetooth device C is received, the quantity (i.e., 2) of target Bluetooth devices in the device group (i.e., the device group 2) where the target Bluetooth device C is located is determined.

S1302: if it is determined that the quantity of target Bluetooth devices in the fourth device group is greater than 1, the third target Bluetooth device is removed from the fourth device group, a fifth device group is created for the third target Bluetooth device in the target display list, and the third target Bluetooth device is added to the fifth device group; where a device identifier of the third target Bluetooth device is presented in the fifth device group.

In the embodiment of the present disclosure, since the connection state of the target Bluetooth devices in the same one device group is the same and are presented as the same one device on the display, if it is determined that the quantity of target Bluetooth devices in the fourth device group is greater than 1, it means that the connection state of the third target Bluetooth device in the fourth device group has changed, while the connection state of other target Bluetooth devices has not changed. Obviously, the third target Bluetooth device cannot be presented as the same device as other target Bluetooth devices in the fourth device group. At this time, the third target Bluetooth device needs to be moved to a new device group and presented based on the new device group.

In the embodiment of the present disclosure, when determining that the quantity of target Bluetooth devices in the fourth device group is greater than 1, the third target Bluetooth device is first removed from the fourth device group, and the fifth device group is created for the third target Bluetooth device in the target display list, and the third target Bluetooth device is added to the fifth device group.

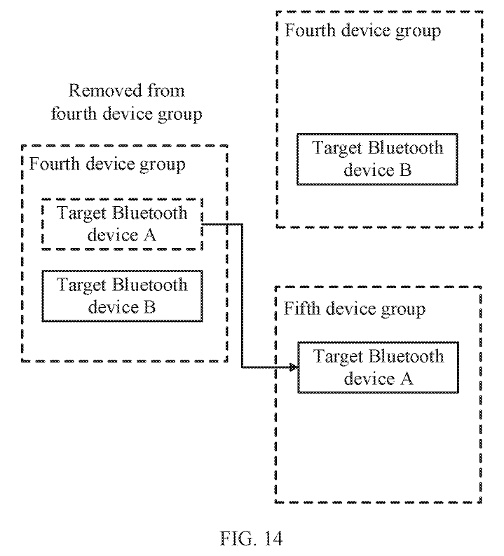

FIG. 14 is a schematic processing diagram when updating the connection states of the target Bluetooth devices according to some embodiments. When the display device receives a connection state switching message for the target Bluetooth device A, it determines the quantity of target Bluetooth devices in the fourth device group where the target Bluetooth device A is located. At this time, the quantity of target Bluetooth devices in the fourth device group is 2, then the target Bluetooth device A is removed from the fourth device group, and a new device group, e.g., the fifth device group, is created, and then the target Bluetooth device A is moved into the fifth device group. Since the target Bluetooth device A and the target Bluetooth device B are in different device groups, they are displayed as two devices on the display at this time, such as “target Bluetooth device A (left), connected” and “target Bluetooth device B (right), unconnected”.

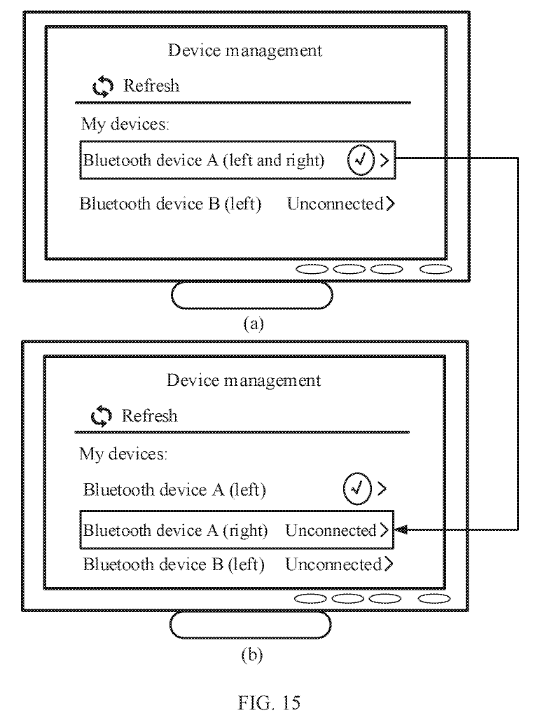

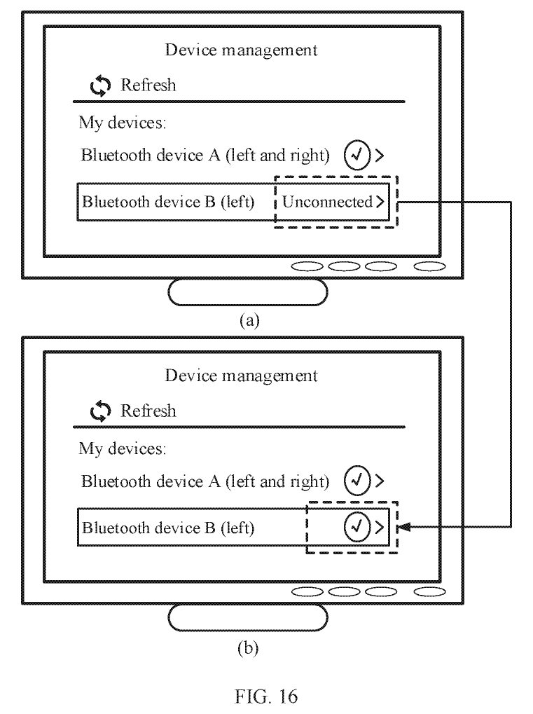

FIG. 15 is a schematic diagram of updating a device management page according to some embodiments. The Bluetooth device A (left and right) presented on the page shown in (a) of FIG. 15 indicates that the left ear device and the right ear device of the Bluetooth device A are both in a connected state. When a message indicating that the connection state of the left ear device of the Bluetooth device A is switched from a connected state to an unconnected state is received, since the quantity of target Bluetooth devices in the Bluetooth device A (left and right) is greater than 1, the left ear device of the Bluetooth device A is removed from the Bluetooth device A (left and right), and a Bluetooth device A (left), i.e., the fifth device group, is created for the left ear device of the Bluetooth device A, and the left ear device of the Bluetooth device A is added to the Bluetooth device A (left). As shown in (b) of FIG. 15, the Bluetooth device A (left) is presented on the page, indicating that the left ear device of the Bluetooth device A is in an unconnected state. At this time, the right ear device of the Bluetooth device A is still in a connected state, and the device group identifier is updated to the Bluetooth device A (right).

S1303: if it is determined that the quantity of target Bluetooth devices in the fourth device group is not greater than 1, a connection state of the third target Bluetooth device in the fourth device group is updated.

In the embodiment of the present disclosure, if it is determined that the quantity of target Bluetooth devices in the fourth device group is not greater than 1, it means that the fourth device group only includes the third target Bluetooth device. At this time, it is only necessary to update the connection state of the third target Bluetooth device in the fourth device group.

FIG. 16 is a schematic diagram of updating another device management page according to some embodiments. The Bluetooth device B (left) presented on the page shown in (a) of FIG. 16 indicates that the left ear device of the Bluetooth device B is in an unconnected state. When a message indicating that the connection state of the left ear device of the Bluetooth device B is switched from an unconnected state to a connected state is received, since the quantity of target Bluetooth devices in the Bluetooth device B (left) is not greater than 1, it is only necessary to update the connection state of the left ear device of the Bluetooth device B to a connected state. In (b) of FIG. 16, a schematic diagram of updating the connection state of the left ear device of the Bluetooth device B to a connected state is shown.

It can be seen that according to the display manner of the Bluetooth device in some embodiments, when a connection state switching message for the third target Bluetooth device is received, the display manner for the third target Bluetooth device can be determined based on the quantity of devices in the fourth device group where the third target Bluetooth device is located. When it is determined that the quantity of devices in the fourth device group is greater than 1, the third target Bluetooth device is removed from the fourth device group, and a fifth device group is created and the third target Bluetooth device is added to the fifth device group; and when it is determined that the quantity of devices in the fourth device group is not greater than 1, the connection state of the third target Bluetooth device is updated, thereby realizing the updated display of the connection state of the Bluetooth device.

In practice, for two target Bluetooth devices (i.e., the left ear device and the right ear device) with the same connection state and HiSyncID, if the user wants to unpair the two target Bluetooth devices, etc., it is necessary to perform operations respectively on the left ear device and the right ear device to achieve the unpairing of the Bluetooth headsets. The above operation process is relatively cumbersome for the user and affects the user experience.

To this end, in the embodiment of the present disclosure, when receiving a target interaction operation for any target Bluetooth device in the first device group, interaction processing corresponding to the target interaction operation can be performed on each target Bluetooth device in the first device group, thereby enabling the user to operate other devices in the device group to which one device belongs while operating this one device, thereby improving the user’s interaction experience.

In the embodiment of the present disclosure, the target interaction operation for any target Bluetooth device may include at least one of an unpairing operation, a disconnection operation, or a reconnection operation for the target Bluetooth device.

For example, assuming that the first device group may include the Bluetooth device A, the Bluetooth device B and the Bluetooth device C, when the display device receives an unpairing operation for the Bluetooth device B in the first device group, it performs interactive processing corresponding to the unpairing operation on each target Bluetooth device (i.e., Bluetooth device A, Bluetooth device B and Bluetooth device C) in the first device group, thereby achieving that when an unpairing operation is performed on any target Bluetooth device in the device group, all target Bluetooth devices in the device group can be unpaired at the same time, thereby improving the user’s interactive experience.

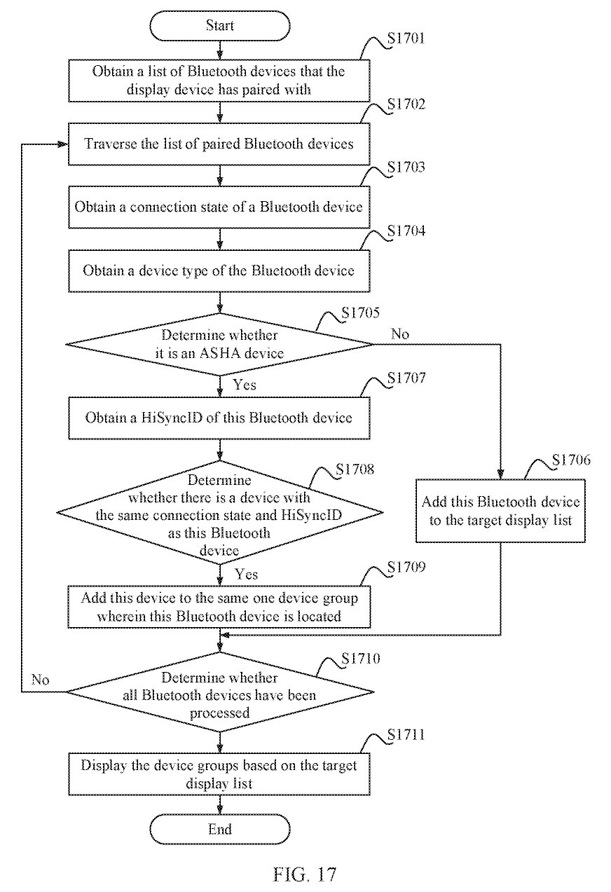

FIG. 17 is a schematic diagram of a display processing flow chart for Bluetooth devices according to some embodiments, which may include the following steps.

S1701: a list of Bluetooth devices that the display device has paired with is obtained.

S1702: the list of paired Bluetooth devices is traversed.

S1703: a connection state of a Bluetooth device is obtained.

S1704: a device type of this Bluetooth device is obtained.

S1705: whether this Bluetooth device is an ASHA device is determined.

S1706: if it is not an ASHA device, this Bluetooth device is added to the target display list; then the subsequent step S1710 is performed.

S1707: if it is an ASHA device, a HiSyncID of the Bluetooth device is obtained; otherwise, the following steps are performed.

If this Bluetooth device is determined to be a target Bluetooth device that supports the ASHA protocol, the HiSyncID and the left or right ear identifier of the target Bluetooth device are obtained based on the UUID reported by the target Bluetooth device.

S1708: whether a device with the same connection state and HiSyncID as this Bluetooth device exists is determined.

S1709: if it exists, add this device to the same one device group as this Bluetooth device.

It is determined whether there is a Bluetooth device in the target display list whose connection state and HiSyncID are the same as those of the target Bluetooth device. If so, the Bluetooth device is added to the same one device group where the target Bluetooth device is locatged.

S1710: whether all Bluetooth devices have been processed is determined.

S1711: if all have been processed, the device groups are presented based on the target display list; otherwise, the process jumps to the aforementioned step S1702, re-traverse the Bluetooth device list to perform subsequent steps S1703 to S1711 on the devices to be processed in the list.

The foregoing has already achieved group management, unified display, and unified operation of Bluetooth devices supporting the ASHA protocol, effectively solving the technical problems of device identification confusion and cumbersome operations under the traditional management logic. However, in the actual use process of Bluetooth devices supporting the ASHA protocol (especially hearing aid-type devices as the core), volume adjustment is a high-frequency core operation demand for users. Moreover, because the main user group of such devices is hearing-impaired users, whose hearing loss levels in the left and right ears are often different, independent and refined volume adjustment for the left and right ear Bluetooth devices is a rigid usage requirement for such users. However, the Bluetooth device volume adjustment methods in the prior art cannot adapt to this core demand, presenting significant usage defects and adaptation deficiencies.

Currently, volume adjustment methods for Bluetooth devices are mainly divided into two categories. One category is adjustment via physical buttons configured on the Bluetooth device itself. However, hearing aid-type Bluetooth devices supporting the ASHA protocol are typically limited by product form, usually being compact in size, with compact physical button layouts and short operating strokes, and requiring high operational precision. Users, especially elderly hearing-impaired users, are prone to mis-touches and insufficient volume adjustment precision during operation. Moreover, when independently adjusting the volume of the left and right ear devices, the physical buttons on both devices need to be operated separately, making the operation process cumbersome and further degrading the user experience. The other category is centralized adjustment of the audio data volume of the Bluetooth device through an audio playback/control device (such as the display device of the present application). Although this method avoids the drawbacks of operating physical buttons on the Bluetooth device and has become the preferred adjustment method for most users, the volume adjustment logic of existing devices still follows the design concepts of traditional Bluetooth audio protocols such as A2DP. It can only output a unified audio gain parameter for the paired binaural Bluetooth devices, achieving synchronous adjustment of the overall volume. It cannot perform individual gain adjustment of the audio stream based on the independent hardware identifiers of the left and right ear devices. That is, it cannot achieve differentiated and independent volume adjustment for the left ear Bluetooth device or the right ear Bluetooth device, completely failing to meet the core needs of hearing-impaired users to adjust different volumes according to their own hearing conditions in the left and right ears.

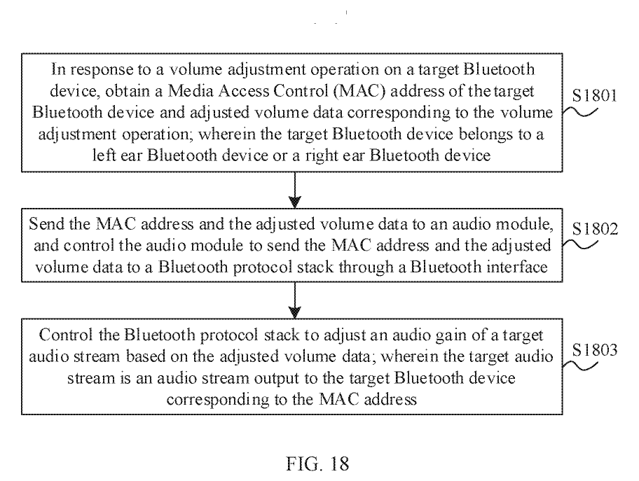

The root cause is that the volume adjustment strategy of existing audio control devices has not been specially adapted for the usage scenarios and hardware characteristics of hearing aid-type Bluetooth devices supporting the ASHA protocol. An audio stream splitting adjustment mechanism based on independent device identifiers has not been established, making it impossible to allocate independent audio gain adjustment parameters for the left and right ear devices. This leads to the adaptation defect in volume adjustment persisting even after group management of Bluetooth devices is achieved, affecting the actual use effect of hearing aid-type Bluetooth devices. To solve the above technical problem of volume adjustment, the present disclosure further proposes an independent volume adjustment solution for Bluetooth devices supporting the ASHA protocol, enabling precise and independent adjustment of the volume of the left and right ear Bluetooth devices respectively based on the display device. This control method will be described in detail below with reference to FIG. 18.

In addition, considering that users often need to adjust the volume when using Bluetooth devices, the current device control methods are mostly to control the volume through physical buttons on the Bluetooth device, or to adjust the volume of the audio data of the Bluetooth device through the audio playback device. However, currently, when adjusting the volume of the Bluetooth device through the audio playback device, the volume of the left ear Bluetooth device and the right ear Bluetooth device can only be adjusted at the same time, and the volume of the left ear Bluetooth device or the right ear Bluetooth device cannot be adjusted separately.

Based on this, in the embodiment of the present disclosure. a control process of a Bluetooth device as shown in FIG. 18 is further provided. The execution subject of the process may be the display device 200 in the embodiment shown in FIG. 1. FIG. 18 is a schematic flow chart of another control method for a Bluetooth device according to some embodiments, which may include the following steps.

S1801: in response to a volume adjustment operation on a target Bluetooth device, obtaining a Media Access Control (MAC) address of the target Bluetooth device and adjusted volume data corresponding to the volume adjustment operation; where the target Bluetooth device is a left ear Bluetooth device or a right ear Bluetooth device.

In some embodiments, the target Bluetooth device may be a left ear Bluetooth device or a right ear Bluetooth device in a pair of Bluetooth devices. A volume bar for the left ear Bluetooth device and a volume bar for the right ear Bluetooth device may be presented on the display of the display device. When a trigger operation for the volume bar of the left ear Bluetooth device is received, the MAC address of the left ear Bluetooth device and the adjusted volume data corresponding to the volume adjustment operation are obtained. For another example, when a trigger operation for the volume bar of the right ear Bluetooth device is received, the MAC address of the right ear Bluetooth device and the adjusted volume data corresponding to the volume adjustment operation are obtained.

In some embodiments, the display device responds to the volume adjustment operation on the target Bluetooth device, which may include: the display device receives a user’s volume adjustment operation on the target Bluetooth device through a remote controller. For example, the user operates the key “volume +” on the remote controller for the left ear Bluetooth device, and the remote controller sends an operation that can be used to increase the volume of the left ear Bluetooth device by 1 to the display device. Accordingly, the display device, in response to the operation of increasing the volume of the left ear Bluetooth device by 1, obtains the MAC address of the left ear Bluetooth device and the adjusted volume data corresponding to the operation of increasing the volume by 1.

For example, if the remote controller receives the voice input of “decrease the volume of the right ear Bluetooth device by 1” through the voice receiving component, the remote controller sends an operation of decreasing the volume of the right ear Bluetooth device by 1 to the display device. Accordingly, the display device, in response to the operation of decreasing the volume of the right ear Bluetooth device by 1, obtains the MAC address of the right ear Bluetooth device and the adjusted volume data corresponding to the operation of decreasing the volume by 1.

In the embodiment of the present disclosure, when the display device receives the volume adjustment operation for the target Bluetooth device, it obtains the MAC address of the target Bluetooth device. The full name of the MAC address is the Media Access Control Address, also known as the physical address or hardware address, which is burned into the chip of the device when it is produced by the device manufacturer and can be used to uniquely identify the device.

For example, assuming that the current volume data of the left ear Bluetooth device is 100, when the display device receives an operation to decrease the volume by 10 for the left ear Bluetooth device, it obtains the MAC address of the left ear Bluetooth device and the adjusted volume data corresponding to the operation of decreasing the volume by 10, that is, 90 is used as the adjusted volume data.

S1802: the MAC address and the adjusted volume data are sent to an audio module, and the audio module is controlled to send the MAC address and the adjusted volume data to a Bluetooth protocol stack through a Bluetooth interface.

In the embodiment of the present disclosure, after obtaining the MAC address of the target Bluetooth device and the adjusted volume data corresponding to the volume adjustment operation, the display device sends the MAC address and the adjusted volume data to the audio module, and controls the audio module to send the MAC address and the adjusted volume data to the Bluetooth protocol stack of the display device through the Bluetooth interface.

The Bluetooth protocol stack refers to a protocol stack including traditional Bluetooth and low-power Bluetooth. The Bluetooth protocol stack can adjust the audio gain of the audio stream based on the received volume data to control the volume of the audio stream.

In some embodiments, after the display device sends the MAC address and adjusted volume data of the target Bluetooth device to the audio module, it can also control the audio module to store the MAC address and the adjusted volume data with a corresponding relationship to a data storage module, so that the display device can display the adjusted volume data of the target Bluetooth device based on the corresponding relationship between the MAC address and the adjusted volume data in the data storage module.

S1803: the Bluetooth protocol stack is controlled to adjust an audio gain of a target audio stream based on the adjusted volume data; where the target audio stream is an audio stream output to the target Bluetooth device corresponding to the MAC address.

In the embodiment of the present disclosure, after controlling the audio module to send the MAC address and the adjusted volume data to the Bluetooth protocol stack through the Bluetooth interface, the display device can also control the Bluetooth protocol stack to adjust the audio gain of the target audio stream based on the adjusted volume data.

Among them, the audio gain can be used to indicate the audio playback capability of the Bluetooth device. Adjusting the audio gain of the audio stream sent to the Bluetooth device can change the volume of the Bluetooth device. In practice, the gain can be used to indicate the ratio of audio input to audio output.

In some embodiments, upon receiving the target audio stream from the display device, the target Bluetooth device can play the target audio stream.

In the control method for the Bluetooth device according to some embodiments, first, in response to the volume adjustment operation for the target Bluetooth device, the MAC address of the target Bluetooth device and the adjusted volume data corresponding to the volume adjustment operation are obtained; where the target Bluetooth device belongs to the left ear Bluetooth device or the right ear Bluetooth device; then, the MAC address and the adjusted volume data are sent to the audio module, and the audio module is controlled to send the MAC address and the adjusted volume data to the Bluetooth protocol stack through the Bluetooth interface; and finally, the Bluetooth protocol stack is controlled to adjust the audio gain of the target audio stream according to the adjusted volume data; where the target audio stream is the audio stream output to the target Bluetooth device corresponding to the MAC address. It can be seen that, in the embodiment of the present disclosure, the independent adjustment of the volume of the left ear Bluetooth device or the right ear Bluetooth device can be realized through the display device, that is, the function of independently controlling the left and right ear volumes of the Bluetooth device is realized.

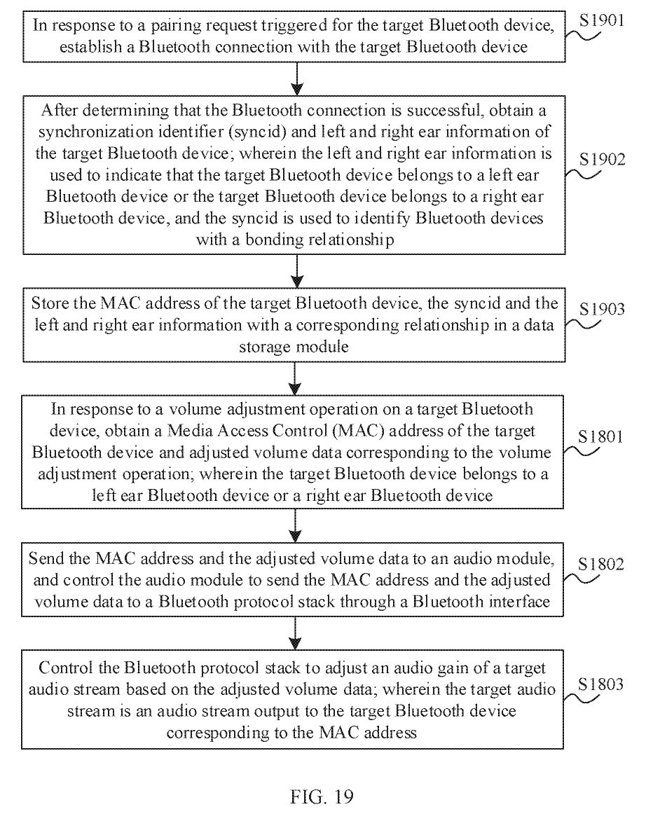

FIG. 19 is an extension and refinement of the embodiment shown in FIG. 18, on the basis of steps S1801 to S1803 shown in FIG. 18, before the above step S1801 (in response to a volume adjustment operation on a target Bluetooth device, obtaining a MAC address of the target Bluetooth device and adjusted volume data corresponding to the volume adjustment operation), the control method for Bluetooth device according to some embodiments may further include the following steps.

S1901: in response to a pairing request triggered for the target Bluetooth device, a Bluetooth connection with the target Bluetooth device is established.

In the embodiment of the present disclosure, before obtaining the MAC address of the target Bluetooth device and the adjusted volume data corresponding to the volume adjustment operation in response to the volume adjustment operation on the target Bluetooth device, it is also possible to establish the Bluetooth connection with the target Bluetooth device in response to the pairing request triggered for the target Bluetooth device.

In some embodiments, the display device may control the Bluetooth module to scan surrounding Bluetooth devices before establishing the Bluetooth connection with the target Bluetooth device in response to the pairing request triggered for the target Bluetooth device.

In practice, when the display device scans the surrounding Bluetooth devices, different Bluetooth devices are presented as different icons. If the scanned Bluetooth device is a Bluetooth keyboard, the keyboard icon is presented for the Bluetooth keyboard. If the scanned Bluetooth device is a Bluetooth controller, the controller icon is presented for the Bluetooth controller. The specific icon to be presented is determined based on the device type information of the scanned Bluetooth device, i.e., the COD (Class of Device) information of the Bluetooth device.

In some embodiments, when the display device controls the Bluetooth module to scan the surrounding Bluetooth devices, if a Bluetooth device is scanned, a preset logo, such as a left ear hearing aid icon or a right ear hearing aid icon, is presented for the Bluetooth device. When a trigger operation corresponding to the hearing aid logo of the target Bluetooth device is received, a Bluetooth connection is established with the target Bluetooth device.

In some embodiments, after controlling the Bluetooth module to scan the Bluetooth device, the display device can also obtain the MAC address of the target Bluetooth device during the process of establishing the Bluetooth connection with the target Bluetooth device.

In some embodiments, the display device may also obtain a Universally Unique Identifier (UUID) of the target Bluetooth device during the process of establishing the Bluetooth connection with the target Bluetooth device in response to the pairing request triggered for the target Bluetooth device.

Among them, UUID can be used to identify the specification of the application layer of the Bluetooth device, that is, whether the Bluetooth device is a device supporting the A2DP protocol, a device supporting the LE Audio protocol, or a device supporting the Hearing Aid protocol.

In practice, after the UUID of the Bluetooth device is obtained, if it is determined based on the UUID that the Bluetooth device is a device that supports the Hearing Aid protocol, it means that the Bluetooth device is a Bluetooth device that supports the Hearing Aid protocol.

S1902: after determining that the Bluetooth connection is successful, the synchronization identifier (syncid) and left and right ear information of the target Bluetooth device are obtained; where the left and right ear information can be used to indicate that the target Bluetooth device belongs to a left ear Bluetooth device or the target Bluetooth device belongs to a right ear Bluetooth device, and the syncid can be used to identify Bluetooth devices with a bonding relationship.

In the embodiment of the present disclosure, after determining that the Bluetooth connection is successfully established with the target Bluetooth device, the display device obtains the synchronization identifier (syncid) and the left and right ear information of the target Bluetooth device.

In practice, for a left ear Bluetooth device and a right ear Bluetooth device with a bonding relationship produced by the same manufacturer, the left ear Bluetooth device and the right ear Bluetooth device have the same syncid, that is, the syncid can be used to identify the Bluetooth devices with a bonding relationship.

In the embodiment of the present disclosure, the left and right ear information may be used to identify that the target Bluetooth device belongs to the left ear Bluetooth device or the target Bluetooth device belongs to the right ear Bluetooth device.

S1903: the MAC address of the target Bluetooth device, the syncid, and the left and right ear information having a corresponding relationship are stored in a data storage module.

In an embodiment of the present disclosure, after obtaining the syncid and left and right ear information of the target Bluetooth device, the MAC address, syncid, and left and right ear information of the target Bluetooth device with the corresponding relationship can be stored in the data storage module, so that the display device can obtain the MAC address, the syncid, and the left and right ear information of the target Bluetooth device from the data storage module based on the above corresponding relationship and display them.

In some embodiments, after obtaining the synchronization identifier (syncid) and left and right ear information of the target Bluetooth device, the audio module can also be controlled to splice the mac address and the left and right ear information of the target Bluetooth device to store them in the data storage module, e.g., store them in the form of the name = “device 1-mac address-left ear” in the data storage module.

S1801: in response to a volume adjustment operation on a target Bluetooth device, obtaining a MAC address of the target Bluetooth device and adjusted volume data corresponding to the volume adjustment operation; where the target Bluetooth device is a left ear Bluetooth device or a right ear Bluetooth device.

In some embodiments, after the MAC address, the syncid, and the left and right ear information of the target Bluetooth device with a corresponding relationship are stored in the data storage module, when the volume adjustment operation for the target Bluetooth device is received, the MAC address of the target Bluetooth device can be obtained from the data storage module, and the adjusted volume data can be determined based on the volume adjustment operation.

S1802: the MAC address and the adjusted volume data are sent to an audio module, and the audio module is controlled to send the MAC address and the adjusted volume data to a Bluetooth protocol stack through a Bluetooth interface.

S1803: the Bluetooth protocol stack is controlled to adjust an audio gain of a target audio stream based on the adjusted volume data; where the target audio stream is an audio stream output to the target Bluetooth device corresponding to the MAC address.

In the control method for the Bluetooth device according to some embodiments, first, in response to the pairing request triggered for the target Bluetooth device, the Bluetooth connection is established with the target Bluetooth device; after determining that the Bluetooth connection is successful, the synchronization identifier (syncid) and the left and right ear information of the target Bluetooth device are obtained; then, the mac address, the syncid, and the left and right ear information of the target Bluetooth device with a corresponding relationship are stored in the data storage module; in response to the volume adjustment operation for the target Bluetooth device, the mac address of the target Bluetooth device and the adjusted volume data corresponding to the volume adjustment operation are obtained; where the target Bluetooth device belongs to the left ear Bluetooth device or the right ear Bluetooth device; then, the mac address and the adjusted volume data are sent to the audio module, and the audio module is controlled to send the mac address and the adjusted volume data to the Bluetooth protocol stack through the Bluetooth interface; further, the Bluetooth protocol stack is controlled to adjust the audio gain of the target audio stream based on the adjusted volume data; where the target audio stream is the audio stream output to the target Bluetooth device corresponding to the mac address. It can be seen that, in the embodiment of the present disclosure, the independent adjustment of the volume of the left ear Bluetooth device or the right ear Bluetooth device can be realized through the display device.

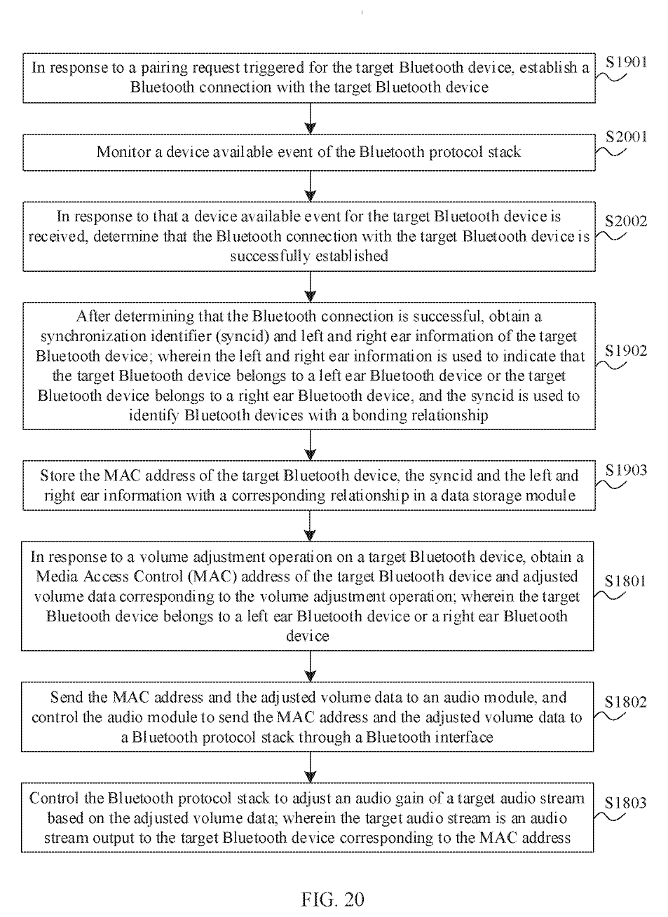

FIG. 20 is an extension and refinement of the embodiment shown in FIG. 19, on the basis of steps S1901 to S1903 and steps S1801 to S1803 shown in FIG. 19, after the above step S1901 (in response to the pairing request triggered for the target Bluetooth device, establishing the Bluetooth connection with the target Bluetooth device), the control method for the Bluetooth device according to some embodiments may further include the following steps.

S1901: in response to a pairing request triggered for the target Bluetooth device, a Bluetooth connection with the target Bluetooth device is established.

S2001: a device available event device available of the Bluetooth protocol stack is monitored.

In practice, the display device can also monitor the device available event of the Bluetooth protocol stack during the process of establishing the Bluetooth connection with the target Bluetooth device. If the display device has established the Bluetooth connection with the target Bluetooth device, the display device can monitor the device available event of the Bluetooth protocol stack.

The device available event may be used to indicate that the display device is currently connected to an available device. For example, assuming that the display device is currently successfully connected to a Bluetooth speaker, the display device can monitor the device available event of the Bluetooth protocol stack.

For the display device, as long as it is currently connected to a Bluetooth device, it can receive the device available event of the Bluetooth protocol stack. Therefore, after monitoring the device available event of the Bluetooth protocol stack, the display device needs to further determine whether the successfully connected device is the target Bluetooth device.

S2002: when a device available event for the target Bluetooth device, it is determined that the Bluetooth connection is successfully established with the target Bluetooth device.

In practice, the target Bluetooth device may report a device available event of the target Bluetooth device to the display device during the process of establishing a Bluetooth connection with the display device. When the display device receives the device available event for the target Bluetooth device, the display device determines whether the Bluetooth connection with the target Bluetooth device is successfully established.

S1902: after determining that the Bluetooth connection is successful, the synchronization identifier (syncid) and left and right ear information of the target Bluetooth device are obtained; where the left and right ear information can be used to indicate that the target Bluetooth device belongs to a left ear Bluetooth device or the target Bluetooth device belongs to a right ear Bluetooth device, and the syncid can be used to identify Bluetooth devices with a bonding relationship.

In some embodiments, after determining that a Bluetooth connection is successfully established with the target Bluetooth device, the display device can also obtain the capability information and syncid reported by the target Bluetooth device based on the MAC address of the target Bluetooth device, where the capability information may include single and double ear information as well as left and right ear information of the target display device.

S1903: the MAC address of the target Bluetooth device, the syncid, and the left and right ear information having a corresponding relationship are stored in a data storage module.

In some embodiments, after the display device stores the MAC address, the syncid, and the left and right ear information of the target Bluetooth device with a corresponding relationship to the data storage module, the display device can also present the target device information for the target Bluetooth device based on the above corresponding relationship stored in the data storage module when receiving a display trigger operation of the volume adjustment page corresponding to the target Bluetooth device, so that the user can understand through the target device information which pair of Bluetooth devices the left ear Bluetooth device or right ear Bluetooth device to be adjusted belongs to.

In other embodiments, after the display device stores the MAC address, the syncid, and the left and right ear information of the target Bluetooth device with the corresponding relationship in the data storage module, the display device can also obtain the latest volume data from the data storage module and synchronize it to the target Bluetooth device after the display device is restarted.

S1801: in response to a volume adjustment operation on a target Bluetooth device, obtaining a Media Access Control (MAC) address of the target Bluetooth device and adjusted volume data corresponding to the volume adjustment operation; where the target Bluetooth device is a left ear Bluetooth device or a right ear Bluetooth device.

S1802: the MAC address and the adjusted volume data are sent to an audio module, and the audio module is controlled to send the MAC address and the adjusted volume data to a Bluetooth protocol stack through a Bluetooth interface.

S1803: the Bluetooth protocol stack is controlled to adjust an audio gain of a target audio stream based on the adjusted volume data; where the target audio stream is an audio stream output to the target Bluetooth device corresponding to the MAC address.

In the control method for the Bluetooth device according to some embodiments, first, in response to the pairing request triggered for the target Bluetooth device, the Bluetooth connection is established with the target Bluetooth device; after determining that the Bluetooth connection is successful, the synchronization identifier (syncid) and the left and right ear information of the target Bluetooth device are obtained; then, the mac address, the syncid, and the left and right ear information of the target Bluetooth device with a corresponding relationship are stored in the data storage module; in response to the volume adjustment operation for the target Bluetooth device, the mac address of the target Bluetooth device and the adjusted volume data corresponding to the volume adjustment operation are obtained; where the target Bluetooth device belongs to the left ear Bluetooth device or the right ear Bluetooth device; then, the mac address and the adjusted volume data are sent to the audio module, and the audio module is controlled to send the mac address and the adjusted volume data to the Bluetooth protocol stack through the Bluetooth interface; further, the Bluetooth protocol stack is controlled to adjust the audio gain of the target audio stream based on the adjusted volume data; where the target audio stream is the audio stream output to the target Bluetooth device corresponding to the mac address. It can be seen that, in the embodiment of the present disclosure, the independent adjustment of the volume of the left ear Bluetooth device or the right ear Bluetooth device can be realized through the display device.

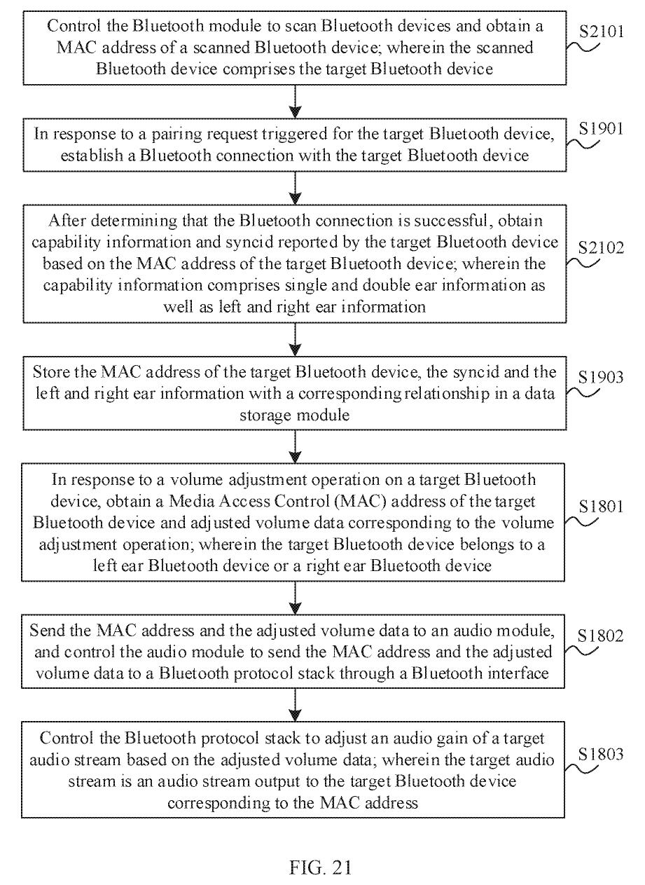

FIG. 21 is an extension and refinement of the embodiment shown in FIG. 19, based on steps S1901 to S1903 and steps S1801 to S1803 shown in FIG. 19, before the above step S1901 (in response to the pairing request triggered for the target Bluetooth device, establishing a Bluetooth connection with the target Bluetooth device), and replacing step S1902 (after determining that the Bluetooth connection is successful, obtaining the syncid and the left and right ear information of the target Bluetooth device) with step S2102, the control method for the Bluetooth device according to some embodiments may further include the following steps.

S2101: the Bluetooth module is controlled to scan Bluetooth devices, and the MAC address of the scanned Bluetooth device is obtained; where the scanned Bluetooth device may include the target Bluetooth device.

In some embodiments, when entering the device management page, the display device automatically controls the Bluetooth module to scan nearby Bluetooth devices, and during the scanning process, obtains the MAC address of the scanned Bluetooth device, where the target Bluetooth device belongs to the scanned Bluetooth device.

In some embodiments, the display device controls the Bluetooth module to scan nearby Bluetooth devices, and can also control the display to present the scanned Bluetooth devices. The scanned devices may include audio receiving devices supporting Bluetooth functions, such as headphones, speakers, hearing aids, and other devices, and may further include devices such as mice, keyboards, and electronic pens supporting Bluetooth functions.

The Bluetooth module can be used to exchange information with other devices supporting the Bluetooth function through the Bluetooth protocol. For example, the display device can scan other devices supporting the Bluetooth function through the Bluetooth module.

S1901: in response to a pairing request triggered for the target Bluetooth device, a Bluetooth connection with the target Bluetooth device is established.

In some embodiments, during the process of controlling the display device to present the scanned Bluetooth devices, the display device may also establish a Bluetooth connection with the target Bluetooth device in response to a pairing request triggered for the target Bluetooth device among the scanned Bluetooth devices.

S2102: after determining that the Bluetooth connection is successful, based on the MAC address of the target Bluetooth device, capability information and syncid reported by the target Bluetooth device are obtained; where the capability information may include single and double ear information as well as left and right ear information.

In the embodiment of the present disclosure, after determining that the Bluetooth connection is successfully established with the target Bluetooth device, the display device can obtain capability information and syncid reported by the target Bluetooth device based on the MAC address of the target Bluetooth device obtained during the scanning process. The syncid can be used to identify the bonding relationship between the target Bluetooth device and other Bluetooth devices.

In the embodiment of the present disclosure, the capability information reported by the target Bluetooth device may include single and double ear information as well as left and right ear information of the target Bluetooth device. The single and double ear information may be used to identify the target Bluetooth device is a single ear device or a double ear device, and the left and right ear information may be used to identify the target Bluetooth device is a left ear Bluetooth device or a right ear Bluetooth device.

Exemplarily, assuming that the syncid of the target Bluetooth device A is 001, and the target Bluetooth device is a left ear Bluetooth device, the Bluetooth device having a bonding relationship with the target Bluetooth device A may be the Bluetooth device B which is a right ear Bluetooth device and has a syncid of 001.

It should be noted that in the embodiment of the present disclosure, the display device obtains the MAC address of the target Bluetooth device while controlling the Bluetooth module to scan the Bluetooth device, and the syncid of the target Bluetooth device is obtained after successfully establishing the Bluetooth connection with the target Bluetooth device.

S1903: the MAC address of the target Bluetooth device, the syncid, and the left and right ear information having a corresponding relationship are stored in a data storage module.

In the embodiment of the present disclosure, after the display device obtains the capability information reported by the target Bluetooth device based on the MAC address of the target Bluetooth device, the display device determines the corresponding relationship between the MAC address, the syncid, and the left and right ear information of the target Bluetooth device, and stores the MAC address, the syncid, and the left and right ear information of the target Bluetooth device with the corresponding relationship in the data storage module. When the MAC address of the target Bluetooth device is subsequently obtained, the syncid and the left and right ear information of the target Bluetooth device can be obtained from the data storage module based on the above corresponding relationship.

In some embodiments, after the display device stores the MAC address, syncid, and left and right ear information of the target Bluetooth device with a corresponding relationship to the data storage module, the display device can also, in response to the display trigger operation of the volume adjustment page corresponding to the target Bluetooth device, obtain the syncid and left and right ear information corresponding to the MAC address of the target Bluetooth device from the data storage module; and further, based on the syncid and the left and right ear information, control the display to present the target device information for the target Bluetooth device on the volume adjustment page.

In the embodiment of the present disclosure, the display trigger operation of the volume adjustment page corresponding to the target Bluetooth device may include: in the process of presenting successfully connected Bluetooth devices on the device management page, in response to a click operation on the target Bluetooth device in the Bluetooth devices, controlling the display to present the volume adjustment page corresponding to the target Bluetooth device.

In practice, since the MAC address of a device can be used to uniquely identify the device, when a display operation of a volume adjustment page corresponding to a target Bluetooth device is received, the syncid and the left and right ear information corresponding to the MAC address of the target Bluetooth device can be obtained from the data storage module, so that the target device information of the target Bluetooth device can be presented on the volume adjustment page based on the syncid and the left and right ear information.

Among them, the target device information can be used to describe the device information of the target Bluetooth device. For example, the target device information may include a Bluetooth device identifier and the left and right ear information. The target device identifier can be used to identify the bonding relationship to which the target Bluetooth device belongs, and the left and right ear information can be used to identify the target Bluetooth device belongs to a left ear Bluetooth device or a right ear Bluetooth device.

After obtaining the syncid and the left and right ear information corresponding to the MAC address of the target Bluetooth device, the display is controlled to present the target device information for the target Bluetooth device on the volume adjustment page based on the syncid and the left and right ear information, so that the user can understand through the target device information which pair of Bluetooth devices the left ear Bluetooth device or right ear Bluetooth device to be adjusted belongs to.

In some embodiments, a volume bar corresponding to the target Bluetooth device may also be presented on the volume adjustment page corresponding to the target Bluetooth device, and the volume bar may be used to indicate the current volume data of the target Bluetooth device. In addition, after receiving the volume adjustment operation for the target Bluetooth device, the display device may also control the volume bar to present the adjusted volume data corresponding to the volume adjustment operation.

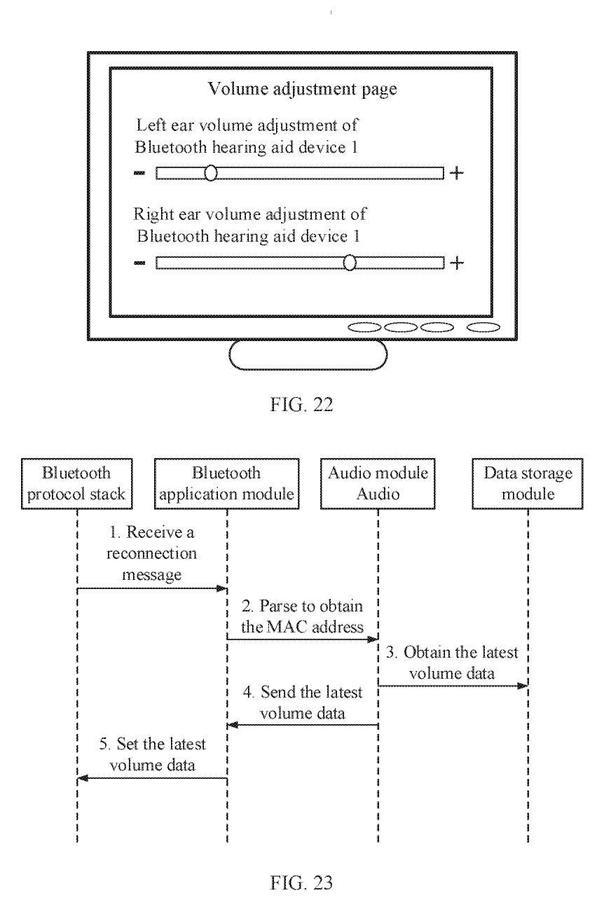

FIG. 22 is a schematic diagram of a volume adjustment page according to some embodiments, where target device information corresponding to the target Bluetooth device, e.g. the left ear volume adjustment of Bluetooth device 1 and the right ear volume adjustment of Bluetooth device 1, is presented on the page, and volume bars corresponding to the target Bluetooth device, such as the left ear volume bar of Bluetooth device 1 and the right ear volume bar of Bluetooth device 1, can also be presented.

S1801: in response to a volume adjustment operation on a target Bluetooth device, obtaining a Media Access Control (MAC) address of the target Bluetooth device and adjusted volume data corresponding to the volume adjustment operation; where the target Bluetooth device is a left ear Bluetooth device or a right ear Bluetooth device.

S1802: the MAC address and the adjusted volume data are sent to an audio module, and the audio module is controlled to send the MAC address and the adjusted volume data to a Bluetooth protocol stack through a Bluetooth interface.

S1803: the Bluetooth protocol stack is controlled to adjust an audio gain of a target audio stream based on the adjusted volume data; where the target audio stream is an audio stream output to the target Bluetooth device corresponding to the MAC address.

In the control method for the Bluetooth device according to some embodiments, first, the Bluetooth module is controlled to scan the Bluetooth device and the MAC address of the scanned Bluetooth device is obtained; where the scanned Bluetooth device may include a target Bluetooth device; in response to a pairing request triggered for the target Bluetooth device, a Bluetooth connection is established with the target Bluetooth device; after determining that the Bluetooth connection is successful, based on the MAC address of the target Bluetooth device, the capability information and the syncid reported by the target Bluetooth device are obtained; where the capability information may include single and double ear information and left and right ear information; then, the mac address, the syncid, and the left and right ear information of the target Bluetooth device with a corresponding relationship are stored in the data storage module; in response to the volume adjustment operation for the target Bluetooth device, the mac address of the target Bluetooth device and the adjusted volume data corresponding to the volume adjustment operation are obtained; where the target Bluetooth device belongs to the left ear Bluetooth device or the right ear Bluetooth device; then, the mac address and the adjusted volume data are sent to the audio module, and the audio module is controlled to send the mac address and the adjusted volume data to the Bluetooth protocol stack through the Bluetooth interface; further, the Bluetooth protocol stack is controlled to adjust the audio gain of the target audio stream based on the adjusted volume data; where the target audio stream is the audio stream output to the target Bluetooth device corresponding to the mac address. It can be seen that, in the embodiment of the present disclosure, the independent adjustment of the volume of the left ear Bluetooth device or the right ear Bluetooth device can be realized through the display device.

In some embodiments, when the display device receives a reconnection message from a target Bluetooth device, first, the display device parses the MAC address of the target Bluetooth device from the reconnection message, and sends the MAC address to the audio module; then, controls the audio module to obtain the latest volume data corresponding to the MAC address of the target Bluetooth device from the data storage module, and sends the MAC address and the latest volume data of the target Bluetooth device the Bluetooth protocol stack. Further, the Bluetooth protocol stack is controlled to output an audio stream to the target Bluetooth device corresponding to the MAC address based on the latest volume data.

In some embodiments, after receiving the reconnection message of the target Bluetooth device and before parsing the MAC address of the target Bluetooth device from the reconnection message, the reconnection message of the Bluetooth device can also be monitored in response to restarting the display device.

In practice, when the display device is restarted, the display device will detect whether there is a Bluetooth device that requests to re-establish the Bluetooth connection, and the specific implementation is to monitor the reconnection message of the Bluetooth device.

During the display device monitors the reconnection message of the Bluetooth device, if the display device has previously established a Bluetooth connection with the target Bluetooth device and the target Bluetooth device is sending a reconnection message to the display device, the display device can parse the MAC address of the target Bluetooth device from the reconnection message after receiving the reconnection message of the target Bluetooth device.

Further, the audio module is controlled to obtain the latest volume data corresponding to the MAC address from the data storage module, and the MAC address and the latest volume data are sent to the Bluetooth protocol stack. The latest volume data is the most recent volume data or the previous volume data stored in the data storage module.

It can be seen that the display device in the embodiment of the present disclosure can monitor the reconnection message of the target Bluetooth device when restarting, and parse the MAC address of the target Bluetooth device from the reconnection message, and then obtain the latest volume data based on the MAC address, and control the Bluetooth protocol stack to output the audio stream to the target Bluetooth device based on the latest volume data, thereby realizing the function of automatically synchronizing the latest volume data to the target Bluetooth device when restarting.

In some embodiments, after the display device sends the MAC address of the target Bluetooth device to the audio module, the display device can also control the audio module to obtain the syncid corresponding to the MAC address from the data storage module, and determine the first Bluetooth device corresponding to the syncid based on the historical data in a storage. The first Bluetooth device is a Bluetooth device that has a bonding relationship with the target Bluetooth device, that is, the syncid of the first Bluetooth device is the same as the syncid of the target Bluetooth device.

As shown in FIG. 22, assuming that the target Bluetooth device presented on the volume adjustment page is the left ear Bluetooth device of the Bluetooth device 1, after the display device sends the MAC address of the left ear Bluetooth device of the Bluetooth device 1 to the audio module, the audio module is controlled to obtain the syncid corresponding to the MAC address from the data storage module, and then the first Bluetooth device, i.e., the right ear Bluetooth device of Bluetooth device 1, that has a bonding relationship with the left ear Bluetooth device of Bluetooth device 1 is determined.

In practice, the scenario in which the display device receives the reconnection message of the target Bluetooth device may include: after the display device establishes a Bluetooth connection with the target Bluetooth device and obtains the syncid and the left and right ear information of the target Bluetooth device, if the display device is powered on and restarted, the latest volume data saved in the data storage module can be synchronized to the target Bluetooth device, thereby realizing the individual control of the volume of the target Bluetooth device.

FIG. 23 is a schematic diagram of a scenario of synchronizing audio data after the display device is restarted according to some embodiments. When the Bluetooth application module in the display device receives a reconnection message from the target Bluetooth device, it parses the MAC address of the target Bluetooth device from the reconnection message, and then sends the MAC address to the audio module; controls to obtain the latest volume data corresponding to the MAC address from the data storage module, and sends the MAC address and the latest volume data to the Bluetooth application module, the Bluetooth application module sending the MAC address and the latest volume data to the Bluetooth protocol stack; and finally controls the Bluetooth protocol stack to output the audio stream to the target Bluetooth device corresponding to the MAC address based on the latest volume data.

Through the above process, in the device control method provided by an embodiment of the present disclosure, the target Bluetooth devices with the same connection state and HiSyncID can be added to the same one device group, and be presented as the same device group on the display, thereby realizing the display function for Bluetooth devices supporting the ASHA protocol. Furthermore, the independent adjustment of the volume of the left ear Bluetooth device or the right ear Bluetooth device can be realized through the display device, that is, the function of independently controlling the left and right ear volumes of the Bluetooth device is realized.

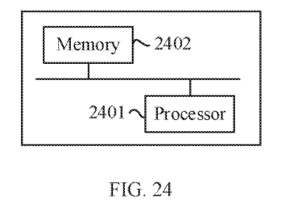

FIG. 24 is a schematic structural diagram of an electronic device according to some embodiments, and the electronic device may be the above-mentioned display device, terminal device, or audio receiving device. As shown in FIG. 24, the electronic device may include: a processor 2401, a memory 2402, and a computer program stored in the memory 2402 and executable on the processor 2401, and when the computer program is executed by the processor 2401, the method in the above-mentioned embodiments involves the device control method executed by the display device.

The embodiment of the present disclosure provides a computer-readable storage medium, on which a computer program is stored, and when the computer program is executed by a processor, each process of the device control method described above is implemented, and the same technical effect can be achieved. To avoid repetition, it is not repeated here. The computer-readable storage medium can be a read-only memory (ROM), a random access memory (RAM), a magnetic disk, or an optical disk, etc.

The present disclosure provides a computer program product, which may include a computer program. When the computer program is executed on a computer, the computer implements the above-mentioned device control method.

For the convenience of explanation, the above description has been made in conjunction with specific embodiments. However, the above discussion in some embodiments is not intended to be exhaustive or limit the embodiments to the specific forms disclosed above. According to the above teachings, various modifications and variations can be obtained. The selection and description of the above embodiments are to better explain the principles and practical applications, so that those skilled in the art can better use the embodiments and various different variations of the embodiments suitable for specific use considerations.

What is claimed is:

1. A display device, comprising:
a display, configured to present an image and/or a user input interface;
the user input interface, configured to receive a command from a user;
a Bluetooth module, configured to perform an operation related to a Bluetooth protocol;
a communicator, configured to communicate with an external device based on a predetermined protocol;
a memory, configured to store data associated with the display device and computer instructions; and
at least one processor, connected to the display, the user input interface, the Bluetooth module, the communicator, and the memory, and configured to execute the computer instructions to cause the display device to:
obtain a list of paired Bluetooth devices; wherein the list of paired Bluetooth devices comprises at least one Bluetooth device;
add target Bluetooth devices with the same connection state and Hearing Instrument Synchronization identifier (HiSyncID) in the list of paired Bluetooth devices to one device group in a target display list; wherein the target Bluetooth devices support an Audio Streaming for Hearing Aid (ASHA) protocol, the connection state comprises a connected state and an unconnected state, the target display list comprises at least a first device group, and the first device group comprises at least two target Bluetooth devices; and
control the display to present a first group identifier and a connection state identifier corresponding to the first group identifier based on the target display list; wherein the first group identifier is used to identify the first device group in the target display list, and the connection state identifier is used to indicate the connection state of the target Bluetooth devices in the first device group.

2. The display device according to claim 1, wherein the at least one processor is further configured to execute the computer instructions to cause the display device to:
before said adding the target Bluetooth devices with the same connection state and HiSyncID in the list of paired Bluetooth devices to one device group in the target display list, obtain the connection state of the target Bluetooth devices in the list of paired Bluetooth devices; and
obtain the HiSyncID of the target Bluetooth devices based on Universally Unique Identifiers (UUIDs) reported by the target Bluetooth devices.

3. The display device according to claim 1, wherein the at least one processor is further configured to execute the computer instructions to cause the display device to:
traverse the list of paired Bluetooth devices, and match a HiSyncID of a first target Bluetooth device in the list of paired Bluetooth devices against the HiSyncID of the target Bluetooth devices in each device group in the target display list; and
in response to that the HiSyncID of the first target Bluetooth device successfully matches a HiSyncID of a second target Bluetooth device in a second device group, add the first target Bluetooth device to the second device group.

4. The display device according to claim 3, wherein the at least one processor is further configured to execute the computer instructions to cause the display device to:
in response to that the HiSyncID of the first target Bluetooth device fails to match the HiSyncID of the target Bluetooth devices in each device group in the target display list, create a third device group for the first target Bluetooth device in the target display list, and add the first target Bluetooth device to the third device group.

5. The display device according to claim 1, wherein the at least one processor is further configured to execute the computer instructions to cause the display device to:
in response to a connection state switching message for a third target Bluetooth device, determine a quantity of target Bluetooth devices in a fourth device group where the third target Bluetooth device is located; and
in response to determining that the quantity of target Bluetooth devices in the fourth device group is greater than 1, remove the third target Bluetooth device from the fourth device group, create a fifth device group for the third target Bluetooth device in the target display list, and add the third target Bluetooth device to the fifth device group; wherein a device identifier of the third target Bluetooth device is presented in the fifth device group.

6. The display device according to claim 5, wherein the at least one processor is further configured to execute the computer instructions to cause the display device to:
in response to determining that the quantity of target Bluetooth devices in the fourth device group is not greater than 1, update a connection state of the third target Bluetooth device in the fourth device group.

7. The display device according to claim 1, wherein the at least one processor is further configured to execute the computer instructions to cause the display device to:
control the display to present a device identifier, a left or right ear identifier, and a connection state identifier of a fourth target Bluetooth device based on the target display list; wherein the target display list further comprises a sixth device group, and the sixth device group comprises the fourth target Bluetooth device, and the left or right ear identifier is used to identify that the fourth target Bluetooth device belongs to a left ear or a right ear.

8. The display device according to claim 1, wherein the at least one processor is further configured to execute the computer instructions to cause the display device to:
in response to a target interaction operation for any target Bluetooth device in the first device group, perform interaction processing corresponding to the target interaction operation on each target Bluetooth device in the first device group; wherein the target interaction operation comprises at least one of an unpairing operation, a disconnection operation, or a reconnection operation.

9. The display device according to claim 1, wherein the first group identifier is a device identifier of a target Bluetooth device that is preferentially added to the first device group.

10. The display device according to claim 1, wherein the at least one processor is further configured to execute the computer instructions to cause the display device to:
in response to a volume adjustment operation on a target Bluetooth device, obtain a Media Access Control (MAC) address of the target Bluetooth device and adjusted volume data corresponding to the volume adjustment operation; wherein the target Bluetooth device belongs to a left ear Bluetooth device or a right ear Bluetooth device;
send the MAC address and the adjusted volume data to an audio module, and control the audio module to send the MAC address and the adjusted volume data to a Bluetooth protocol stack through a Bluetooth interface; and
control the Bluetooth protocol stack to adjust an audio gain of a target audio stream based on the adjusted volume data; wherein the target audio stream is an audio stream output to the target Bluetooth device corresponding to the MAC address.

11. The display device according to claim 10, wherein the at least one processor is further configured to execute the computer instructions to cause the display device to:
after said sending the MAC address and the adjusted volume data to the audio module, control the audio module to store the MAC address and the adjusted volume data with a corresponding relationship in a data storage module.

12. The display device according to claim 10, wherein the at least one processor is further configured to execute the computer instructions to cause the display device to:
before said obtaining the MAC address of the target Bluetooth device and the adjusted volume data corresponding to the volume adjustment operation, in response to a pairing request triggered for the target Bluetooth device, establish a Bluetooth connection with the target Bluetooth device;
after determining that the Bluetooth connection is successful, obtain a Hearing Instrument Synchronization identifier (HiSyncID and left and right ear information of the target Bluetooth device; wherein the left and right ear information is used to indicate that the target Bluetooth device belongs to a left ear Bluetooth device or the target Bluetooth device belongs to a right ear Bluetooth device, and the HiSyncID is used to identify Bluetooth devices with a bonding relationship; and
store the MAC address of the target Bluetooth device, the HiSyncID, and the left and right ear information with a corresponding relationship in a data storage module.

13. The display device according to claim 12, wherein the at least one processor is further configured to execute the computer instructions to cause the display device to:
before said in response to the pairing request triggered for the target Bluetooth device, establishing the Bluetooth connection with the target Bluetooth device, control the Bluetooth module to scan Bluetooth devices and obtain a MAC address of a scanned Bluetooth device; wherein the scanned Bluetooth device comprises the target Bluetooth device; and
after determining that the Bluetooth connection is successful, obtain capability information and HiSyncID reported by the target Bluetooth device based on the MAC address of the target Bluetooth device; wherein the capability information comprises single and double ear information as well as left and right ear information.

14. The display device according to claim 12, wherein the at least one processor is further configured to execute the computer instructions to cause the display device to:
in response to a display triggering operation for a volume adjustment page corresponding to the target Bluetooth device, obtain the HiSyncID and the left and right ear information corresponding to the MAC address of the target Bluetooth device from the data storage module; and
control the display to present target device information for the target Bluetooth device on the volume adjustment page based on the HiSyncID and the left and right ear information; wherein the target device information comprises a Bluetooth device identifier and a left or right ear identifier, the Bluetooth device identifier is used to identify a bonding relationship to which the target Bluetooth device belongs, and the left or right ear identifier is used to identify that the target Bluetooth device belongs to the left ear Bluetooth device or that the target Bluetooth device belongs to the right ear Bluetooth device.

15. The display device according to claim 12, wherein the at least one processor is further configured to execute the computer instructions to cause the display device to:
after said establishing the Bluetooth connection with the target Bluetooth device, monitor a device available event of the Bluetooth protocol stack; and
in response to that a device available event for the target Bluetooth device is received, determine that the Bluetooth connection with the target Bluetooth device is successfully established.

16. The display device according to claim 10, wherein the at least one processor is further configured to execute the computer instructions to cause the display device to:
after receiving a reconnection message for the target Bluetooth device, parse the reconnection message to obtain the MAC address of the target Bluetooth device, and send the MAC address to the audio module;
control the audio module to obtain latest volume data corresponding to the MAC address from the data storage module, and send the MAC address and the latest volume data to the Bluetooth protocol stack; and
control the Bluetooth protocol stack to output an audio stream to the target Bluetooth device corresponding to the MAC address based on the latest volume data.

17. The display device according to claim 16, wherein the at least one processor is further configured to execute the computer instructions to cause the display device to:
after said sending the MAC address to the audio module, control the audio module to obtain the HiSyncID corresponding to the MAC address from the data storage module, and determine a first Bluetooth device corresponding to the HiSyncID based on historical data in a storage; wherein the first Bluetooth device is a Bluetooth device with a bonding relationship with the target Bluetooth device; and
control the Bluetooth module to establish a Bluetooth connection with the first Bluetooth device.

18. The display device according to claim 16, wherein the at least one processor is further configured to execute the computer instructions to cause the display device to:
after said receiving the reconnection message for the target Bluetooth device, and before said parsing the reconnection message to obtain the MAC address of the target Bluetooth device, in response to restarting of the display device, monitor the reconnection message for a Bluetooth device.

19. A device control method, comprising:
obtaining a list of paired Bluetooth devices; wherein the list of paired Bluetooth devices comprises at least one Bluetooth device;
adding target Bluetooth devices with the same connection state and Hearing Instrument Synchronization identifier (HiSyncID) in the list of paired Bluetooth devices to one device group in a target display list; wherein the target Bluetooth devices support an Audio Streaming for Hearing Aid (ASHA) protocol, the connection state comprises a connected state and an unconnected state, and the target display list comprises at least a first device group, and the first device group comprises at least two target Bluetooth devices; and
controlling the display to present a first group identifier and a connection state identifier corresponding to the first group identifier based on the target display list; wherein the first group identifier is used to identify the first device group in the target display list, and the connection state identifier is used to indicate the connection state of the target Bluetooth devices in the first device group.

20. The device control method according to claim 19, further comprising:
before said adding the target Bluetooth devices with the same connection state and HiSyncID in the list of paired Bluetooth devices to one device group in the target display list, obtaining the connection state of the target Bluetooth devices in the list of paired Bluetooth devices; and
obtaining the HiSyncID of the target Bluetooth devices based on Universally Unique Identifiers (UUIDs) reported by the target Bluetooth devices.
